(19) United States
(12) Patent Application Publication
(10) Pub. No.: US 2010/0074077 A1
(43) Pub. Date: Mar. 25, 2010

(54) OPTICAL HEAD DEVICE AND OPTICAL INFORMATION RECORDING/REPRODUCING DEVICE

(76) Inventor: Ryuichi Katayama, Tokyo (JP)

Correspondence Address: Mr. Jackson Chen, 6535 N. STATE HWY 161, IRVING, TX, 75039, US

(21) Appl. No.: 12/443,020

(22) PCT Filed: Oct. 15, 2007
(86) PCT No.: PCT/JP2007/070058

§ 371 Date: Mar. 26, 2009

(30) Foreign Application Priority Data
Oct. 18, 2006 (JP) 2006-284394

(51) Int. Cl. G11B 7/00

(52) U.S. Cl. 369/53.12; 369/112.23; G9B/7

(57) ABSTRACT

Provided are an optical head device and an optical information recording/reproducing device, which can record/reproduce information to/from at least three kinds of optical recording media of different standards. A light beam emitted from a semiconductor laser is converged on a disk by an objective lens, and a reflected light beam from the disk is received by a photodetector. The optical system includes a liquid crystal refracting lens which can change the focal distance continuously within a predetermined range. The liquid crystal refracting lens has an electrode, and corrects, when the voltage applied to the electrode is changed, such a spherical aberration in the emitting light as changes with the kind of the disk. Moreover, a liquid crystal aperture control element has an electrode, and changes the effective numerical aperture of the objective lens in accordance with the kind of the disk, when the voltage applied to the electrode is changed.

### TECHNICAL FIELD

The present invention relates to an optical head device and an optical information recording/reproducing device for performing recording and reproduction of information to/from at least three kinds of optical recording media of different standards. Note that the optical information recording/reproducing device of the present invention includes both a recording/reproducing device which performs recording/reproduction of information to/from the optical recording media and a reproduction-only device which performs only reproduction from the optical recording media.

### BACKGROUND ART

The recording density in an optical information recording/reproducing device is inversely proportional to a square of a diameter of a light focusing spot formed on an optical recording medium by an optical head device. That is, the recording density becomes increased as the diameter of the light focusing spot becomes smaller. In a CD (compact disk) standard of 4.7 GB capacity, a wavelength of a light source is about 780 nm, and a numerical aperture of an objective lens is 0.45. Further, in a DVD (digital versatile disk) standard of 4.7 GB capacity, a wavelength of a light source is about 650 nm, and a numerical aperture of an objective lens is 0.6.

When the optical recording medium becomes tilted with respect to the objective lens, the shape of the light focusing spot becomes disturbed by a comma aberration, thereby deteriorating a recording/reproducing property. The comma aberration is inversely proportional to the wavelength of the light source and proportional to a cube of the numerical aperture of the objective lens as well as the thickness of a protection layer of the optical recording medium. Thus, a margin of the tilt of the optical recording medium with respect to the recording/reproducing property becomes narrower as the wavelength of the light source becomes shorter and the numerical aperture of the objective lens becomes higher, under a condition with the same thickness of the protection layer of the optical recording medium. Therefore, in standards where the wavelength of the light source is shortened and the numerical aperture of the objective lens is increased for increasing the recording density, the thickness of the protection layer of the optical recording medium is reduced as necessary in order to secure the margin of the tilt of the optical recording medium for the recording/reproducing property. In the CD standard, the thickness of the protection layer of the disk is 1.2 mm. Further, in the DVD standard, the thickness of the protection layer of the disk is 0.6 mm.

Based on those backgrounds, there have been demands for an optical head device and an optical information recording/reproducing device having compatibility, which are capable of performing recording/reproduction of information to/from a plurality of kinds of disks of different standards. In a normal optical head device, the optical system is designed to correct a spherical aberration for a single wavelength and a thickness of a protection layer. Thus, the spherical aberration remains for other wavelengths and thicknesses of the protection layers. When there remains the spherical aberration, the shape of the light focusing spot is disturbed. Thus, it is not possible to perform recording and reproduction in a fine manner. Therefore, it is necessary for the optical head having the interchangeability to be able to correct the spherical aberration in accordance with the kinds of the disks.

As an example of a related optical head device capable of performing recording and reproduction to/from two kinds of disks of different standards such as the DVD standard and the CD standard, there is an optical head device depicted in Patent Document 1. As shown in FIG. 17, in the optical head device depicted in Patent Document 1, a part of light emitted from a semiconductor laser 50 transmits through a beam splitter 51, and passes through a liquid crystal lens 55. Then, the light is converged on a disk 53 by an objective lens 52. Reflected light from the disk 53 passes the objective lens 52 and the liquid crystal lens 55 in an inverse direction. Then, a part of the light is diffracted by the beam splitter 51 and received by photodetectors 54a and 54b.

The liquid crystal lens 55 will be described in details. As shown in FIG. 18A and FIG. 18B, the liquid crystal lens 55 is structured having a liquid crystal polymer 57 between a substrate 56a and a substrate 56b. A lens 58 protruded on the substrate 56b side is formed in the center part of the surface of the substrate 56b on the liquid crystal polymer 57 side, and a diffraction grating 59 is formed in the peripheral part. Electrodes (not shown) for applying an AC voltage to the liquid crystal polymer 57 are formed on the surfaces of the substrates 56a and 56b on the liquid crystal polymer 57 side. Arrows in the drawings show the longitudinal direction of the liquid crystal polymer 57. The liquid crystal polymer 57 has a uniaxial refractive index anisotropy whose optical axis direction is the longitudinal direction. The refractive index for a polarized light component that is in parallel to the longitudinal direction (abnormal light component) is larger than the refractive index for a polarized light component that is perpendicular to the longitudinal direction (normal light component). In the meantime, the refractive indexes of the substrates 56a and 56b are equivalent to the refractive index of the liquid crystal polymer 57 for the abnormal light component. Note here that incident light for the liquid crystal lens 55 is linearly polarized light whose polarized direction is perpendicular to the paper face of the drawing.

When the disk 53 is a disk of the DVD standard, the AC voltage applied to the electrodes is turned off. At this time, as shown in FIG. 18A, the longitudinal direction of the liquid crystal polymer 57 turns to a direction that is perpendicular to the optical axis of the incident light and perpendicular to the paper face of the drawing. Thus, the longitudinal direction of the liquid crystal polymer 57 and the polarized direction of the incident light become in parallel, so that the incident light turns out as abnormal light. Therefore, the light in the center part among the incident light is transmitted without being affected by a refraction effect of the lens 58, and the light in the peripheral part is transmitted without being affected by a diffraction effect of the diffraction grating 59. In the meantime, when the disk 53 is a disk of the CD standard, the AC voltage applied to the electrodes is turned on. At this time, as shown in FIG. 18B, the longitudinal direction of the liquid crystal polymer 57 becomes in parallel to the optical axis of the incident light. Thus, the longitudinal direction of the liquid crystal polymer 57 becomes perpendicular to the polarized direction of the incident light, so that the incident light turns out as normal light. Therefore, the light in the center part among the incident light is refracted, by being affected by the refraction effect of the lens 58 as a concave lens, and the light in the peripheral part is diffracted by being affected by the diffraction effect of the diffraction grating 59.

In the optical head device shown in FIG. 17, the optical system is designed to correct the spherical aberration for the thickness 0.6 mm of the protection layer that is the condition of the DVD standard, when the AC voltage applied to the electrodes is turned off. Thus, the spherical aberration remains for the thickness 1.2 mm of the protection layer that is the condition of the CD standard. However, when the AC voltage to be applied to the electrodes is turned on, the magnification of the objective lens 53 is changed due to the refraction effect of the lens 58. Thereby, a new spherical aberration according thereto is generated, and the remaining spherical aberration for the thickness 1.2 mm of the protection layer is corrected. That is, it is possible to correct the spherical aberration in accordance with the kinds of the disks. Further, in the optical head device shown in FIG. 17, the numerical aperture of the objective lens is determined according to the effective diameter of the objective lens 52, when the AC voltage to be applied to the electrodes is turned off. However, the numerical aperture of the optical lens is determined according to a diameter of a circle that is the boundary between the lens 58 and the diffraction grating 59, when the AC voltage to be applied to the electrodes is turned on. That is, it is possible to control the numerical aperture of the objective lens in accordance with the kinds of the disks.

Recently, a standard in which the wavelength of the light source is set still shorter and the numerical aperture of the objective lens is set still higher in order to further increase the recording density has been proposed or put into practical use. In a standard of capacities of 15 GB-20 GB called an HD DVD (High-density Digital Versatile Disk) standard, the wavelength of the light source is about 405 nm, and the numerical aperture of the objective lens is 0.65. In a standard of capacities of 23.3 GB-27 GB called a BD (Blu-ray Disk) standard, the wavelength of the light source is about 405 nm, and the numerical aperture of the objective lens is 0.85. The thickness of the protection layer of the disk in the HD DVD standard is 0.6 mm, and the thickness of the protection layer of the disk in the BD standard is 0.1 mm.

However, the optical head device depicted in Patent Document 1 cannot perform recording and reproduction of information to/from three or more kinds of disks of different standards such as the disks of the BD standard, the HD DVD standard, the DVD standard, and the CD standard.

Incidentally, as a method for correcting the spherical aberration that changes depending on the kinds of the optical recording media, there is also a method which uses a liquid crystal optical element for correcting the spherical aberration as depicted in Patent Document 2 and Patent Document 3, for example. Further, there is also a method which changes the magnification of the objective lens by changing the optical path length from the light source to the objective lens as depicted in Patent Document 4, for example.

With the method depicted in Patent Documents 2 and 3 using the liquid crystal optical element for correcting the spherical aberration, the liquid crystal optical element generates a phase distribution which offsets a phase distribution by the spherical aberration generated by the objective lens. However, with this method, the center of the objective lens and the center of the liquid crystal optical element are shifted from each other when the objective lens follows an information track and shifts to a direction perpendicular to the information track. Thus, the phase distribution by the spherical aberration generated in the objective lens cannot be offset completely by the phase distribution generated by the liquid crystal optical element. Therefore, the remaining aberration becomes extensive, which results in having such an issue that a fine recording/reproducing property cannot be obtained.

With the method depicted in Patent Document 4 which changes the magnification of the objective lens by changing the optical path length from the light source to the objective lens, a plurality of light sources having different optical path lengths to the objective lenses are provided. Alternatively, the light source itself is moved mechanically. However, with this method, it is also necessary to change the optical path length from the objective lens to the photodetector. This results in having such an issue that the structure of the optical system becomes complicated, since it is necessary to provide a plurality of photodetectors in addition to providing a plurality of light sources or necessary to move the photodetector mechanically in addition to moving the light source mechanically.

### Patent Document 1: Japanese Unexamined Patent Publication 10-92003

### Patent Document 2: Japanese Unexamined Patent Publication 2003-030891

### Patent Document 3: Japanese Unexamined Patent Publication 2006-012391

### Patent Document 4: Japanese Unexamined Patent Publication 2003-296959

It is therefore an object of the present invention to overcome the foregoing issues of the related optical head device, and to provide an optical head device and an optical information recording/reproducing device capable of performing recording and reproduction of information to/from at least three kinds of optical recording media of different standards. Further, it is to provide an optical head device and an optical information recording/reproducing device having a simple-structured optical system, which are capable of avoiding generation of remaining aberrations and obtaining a fine recording/reproducing property.

### DISCLOSURE OF THE INVENTION

In order to achieve the foregoing object, an optical head device according to the present invention is targeted to at least three kinds of optical recording media with information tracks having different optical system conditions to be used. The optical head device includes: light sources, an objective lens which converges emission light emitted from the light sources onto the optical recording medium and forms a light focusing spot; a photodetector which receives reflected light that is converged on the optical recording medium by the lens and reflected thereby; and a light separating device which separates the emission light and the reflected light. The optical head device has a lens system disposed between the light separating device and the objective lens, which can change its focal distance continuously within a prescribed range for correcting a spherical aberration in the emission light, which changes depending on the kinds of the optical recording media.

It is preferable for the lens system to have a variable focal-point lens having an electrode, wherein the variable focal-point lens can change its focal distance according to a change in a voltage applied to the electrode. Further, it is preferable for the variable focal-point lens to be a refractive-type liquid crystal lens. Alternatively, it is preferable for the variable focal-point lens to be a diffraction-type liquid crystal lens, and preferable for the lens system whose focal distance can be continuously changed to include the diffraction-type liquid crystal lens and an auxiliary lens system whose focal distance can be changed continuously. Alternatively, it is preferable for the variable focal-point lens to be a liquid lens.

Further, it is preferable to provide, between the light separating device and the objective lens, an aperture control device which changes an effective numerical aperture of the objective lens depending on the kinds of the optical recording media.

Furthermore, it is preferable for the light sources to be a plurality of light sources whose emission light is of different wavelength from each other.

An optical information recording/reproducing device according to the present invention includes: the optical head device of the present invention described above;

a first circuit system which drives the light sources; a second circuit system which detects a mark/space signal formed along the information track based on an output from the photodetector of the optical head device; a third circuit system which detects, based on the output from the photodetector, a focus error signal indicating a position shift of the optical head device with respect to the information track in an optical axis direction of a light focusing spot and a track error signal indicating a position shift within a plane that is perpendicular to the optical axis, and drives the objective lens of the optical head device based on the focus error signal and the track error signal; and a fourth circuit system which drives the lens system of the optical head device so as to correct the spherical aberration in the emission light, which changes depending on the kinds of the recording media.

With the optical head device and the optical information recording/reproducing device according to the present invention, the focal distance of the lens system is changed continuously. Thereby, the magnification of the objective lens is changed continuously, so that the spherical aberration is changed continuously. Thus, it is possible to set the focal distance of the lens system so as to correct the spherical aberration which changes depending on the kinds of the optical recording media, even if there are three or more kinds of the optical recording media.

Further, as a method for correcting the spherical aberration which changes depending on the kinds of the optical recording media, the optical head device and the optical information recording/reproducing device according to the present invention employ a method which changes the magnification of the objective lens through changing the focal distance of the lens system. With this method, the spherical aberration generated in the objective lens is corrected by the objective lens itself by changing the magnification of the objective lens. Thus, even if the objective lens follows the information track and shifts to the direction perpendicular to the information track, no remaining aberration is generated. Therefore, a fine recording/reproducing property can be achieved. Further, with this method, the optical path length from the light source to the objective lens and the optical path length from the objective lens to the photodetector are constant. Therefore, it is unnecessary to provide a plurality of light sources and photodetectors or to move the light source and the photodetector mechanically. As a result, the structure of the optical system can be simplified.

The present invention makes it possible to perform recording and reproduction of information to/from the three or more kinds optical recording medium of different standards. It is because the magnification of the objective lens can be changed continuously and the spherical aberration can be changed continuously thereby, through changing the focal distance of the lens system continuously. Thus, it is possible to set the focal distance of the lens system so as to correct the spherical aberration which changes depending on the kinds of the optical recording media, even if there are three or more kinds of the optical recording media.

With the present invention, no remaining aberration is generated, a fine recording/reproducing property can be achieved, and the structure of the optical system can be simplified. It is because the present invention employs the method which changes the magnification of the objective lens by changing the focal distance of the lens system, as the method for correcting the spherical aberration which changes depending on the kinds of the optical recording medium.

### BEST MODES FOR CARRYING OUT THE INVENTION

Hereinafter, exemplary embodiments of the invention will be described by referring to the accompanying drawings.

### First Exemplary Embodiment

An optical head device according to a first exemplary embodiment shown in FIG. 1 is capable of performing recording and reproduction of information to/from disks of a BD standard, an HD DVD standard, a DVD standard, and a CD standard, i.e., four kinds of disks of different standards. Hereinafter, this will be described in a concretive manner.

In FIG. 1, the wavelength of light emitted from a semiconductor laser 1a as a light source is 405 nm. The emission light from the semiconductor laser 1a is converted into parallel light from divergent light at a collimator lens 2a, which makes incident as P-polarized light on a polarizing beam splitter 3 as a light separating device. Almost all of the light transmits therethrough and passes through a liquid crystal refracting lens 11 that is a variable focal-point lens which configures a lens system and a liquid crystal aperture control element 16a that is an aperture control device. The light is then converted from linearly polarized light into circularly polarized light at a quarter wavelength plate 4, and converged by an objective lens 5 onto a disk 6 that is an optical recording medium.

The reflected light from the disk 6 passes the objective lens 5 in an inverse direction, which is converted by the quarter wavelength plate 4 from the circularly polarized light into the linearly polarized light whose polarizing direction is orthogonal to the outgoing light. The linearly polarized light passes the liquid crystal aperture control element 16a and the liquid crystal refracting lens 11 in an inverse direction, and makes incident on the polarizing beam splitter 3 as S-polarized light. Almost all the light is reflected thereby, the reflected light passes through a cylindrical lens 7 and a convex lens 8, and it is received by a photodetector 9. In the first exemplary embodiment, light of 405 nm wavelength is used to perform recording and reproduction of information to/from all the four kinds of disks of different standards, i.e., all the disks of the BD standard, the HD DVD standard, the DVD standard, and the CD standard.

The photodetector 9 is placed at an intermediate point of two caustic curves formed by the cylindrical lens 7 and the convex lens 8. The photodetector 9 has four light-receiving sections separated by a dividing line corresponding to a radial direction of the disk 6 (direction perpendicular to information track) and by a dividing line corresponding to a tangential direction (direction in parallel to information track). Based on outputs from the four light-receiving sections of the photodetector 9, a focus error signal, a track error signal, and a mark/space signal recorded on the disk 6 are detected. The focus error signal is detected by a known astigmatism method. The track error signal is detected by a known phase contrast method when the disk 6 is a reproduction-only disk, and the track error signal is detected by a known push-pull method when the disk 6 is a write-once read-many type or a rewritable type optical disk. The mark/space signal is detected based on a high-frequency component that is the sum of the outputs from the four light-receiving sections of the photodetector 9.

As shown in FIGS. 2A, 2B, and 2C, the liquid crystal refracting lens 11 is in a structure in which a liquid crystal polymer 19a and a filler 20a are sandwiched between a substrate 18a and a substrate 18b, and a liquid crystal polymer 19b and a filler 20b are sandwiched between a substrate 18c and the substrate 18b. A refracting lens protruded on the liquid crystal polymer 19a side is formed on the surface of the filler 20a on the liquid crystal polymer 19a side, while a refracting lens protruded on the liquid crystal polymer 19b side is formed on the surface of the filler 20b on the liquid crystal polymer 19b side. Electrodes (not shown) for applying an AC voltage to the liquid crystal polymer 19a are formed on the surfaces of the substrates 18a and 18b on the liquid crystal polymer 19a side, while electrodes (not shown) for applying an AC voltage to the liquid crystal polymer 19b are formed on the surfaces of the substrates 18c and 18b on the liquid crystal polymer 19b side. Arrows in the drawings show the longitudinal direction of the liquid crystal polymers 19a and 19b. The liquid crystal polymers 19a and 19b have a uniaxial refractive index anisotropy whose optical axis direction is the longitudinal direction. Provided that the refractive index for a polarized light component that is in parallel to the longitudinal direction (abnormal light component) is “ne” and the refractive index for a polarized light component that is perpendicular to the longitudinal direction (normal light component) is “no”, “ne” is larger than “no”. In the meantime, the refractive indexes of the fillers 20a and 20b are equivalent to the refractive index for the normal light component of the liquid crystal polymers 19a and 19b. Note here that incident light for the liquid crystal refracting lens 11 in an outgoing path to the disk 6 from the semiconductor laser 1a is linearly polarized light whose polarized direction is in parallel to the paper face of the drawing. The incident light for the liquid crystal refracting lens 11 in an incoming path to the photodetector 9 from the disk 6 is linearly polarized light whose polarized direction is perpendicular to the paper face of the drawing.

When an effective value of the AC voltage to be applied to the electrodes sandwiching the liquid crystal polymer 19a is 1.5 V, the longitudinal direction of the liquid crystal polymer 19a comes to be in a direction that is almost perpendicular to the optical axis of the incident light and in parallel to the paper face of the drawing, as shown in FIG. 2C. Thus, the refractive index of the liquid crystal polymer 19a for the outgoing light becomes “ne”. When the effective value of the AC voltage to be applied to the electrodes sandwiching the liquid crystal polymer 19a is 1.5 V-3.5 V, the longitudinal direction of the liquid crystal polymer 19a forms a prescribed angle with the optical axis on a plane (including the optical axis of the incident light) which is in parallel to the paper face of the drawing, as shown in FIG. 2B. Thus, the refractive index of the liquid crystal polymer 19a for the outgoing light takes an intermediate value of “ne” and “no”. As the effective value of the AC voltage becomes higher, the angle formed by the longitudinal direction of the liquid crystal polymer 19a and the optical axis of the incident light becomes smaller. Thereby, the refractive index of the liquid crystal polymer 19a for the outgoing light becomes close to “no”. The refractive index of the liquid crystal polymer 19a for the outgoing light changes almost linearly with respect to the effective value of the AC voltage.

When the effective value of the AC voltage to be applied to the electrodes sandwiching the liquid crystal polymer 19a is 3.5 V, the longitudinal direction of the liquid crystal polymer 19a comes to be in a direction that is almost in parallel to the optical axis of the incident light, as shown in FIG. 2A. Thus, the refractive index of the liquid crystal polymer 19a for the outgoing light becomes “no”. The refractive index of the liquid crystal polymer 19a for the incoming light becomes “no” regardless of the effective value of the AC voltage applied to the electrodes sandwiching the liquid crystal polymer 19a.

When the effective value of the AC voltage to be applied to the electrodes sandwiching the liquid crystal polymer 19b is 1.5 V, the longitudinal direction of the liquid crystal polymer 19b comes to be in a direction that is almost perpendicular to the optical axis of the incident light and perpendicular to the paper face of the drawing, as shown in FIG. 2C. Thus, the refractive index of the liquid crystal polymer 19b for the incoming light becomes “ne”.

When the effective value of the AC voltage to be applied to the electrodes sandwiching the liquid crystal polymer 19b is 1.5 V-3.5 V, the longitudinal direction of the liquid crystal polymer 19b forms a prescribed angle with the optical axis on a plane (including the optical axis of the incident light) which is perpendicular to the paper face of the drawing, as shown in FIG. 2B. Thus, the refractive index of the liquid crystal polymer 19b for the incoming light takes an intermediate value of “ne” and “no”. As the effective value of the AC voltage becomes higher, the angle formed by the longitudinal direction of the liquid crystal polymer 19b and the optical axis of the incident light becomes smaller. Thereby, the refractive index of the liquid crystal polymer 19b for the incoming light becomes close to “no”. Therefore, the refractive index of the liquid crystal polymer 19b for the incoming light changes almost linearly with respect to the effective value of the AC voltage.

When the effective value of the AC voltage to be applied to the electrodes sandwiching the liquid crystal polymer 19b is 3.5 V, the longitudinal direction of the liquid crystal polymer 19b comes to be in a direction that is almost in parallel to the optical axis of the incident light, as shown in FIG. 2A. Thus, the refractive index of the liquid crystal polymer 19b for the incoming light becomes “no”. The refractive index of the liquid crystal polymer 19b for the outgoing light becomes “no” regardless of the effective value of the AC voltage applied to the electrodes sandwiching the liquid crystal polymer 19b.

As a result, for the outgoing light, the liquid crystal refracting lens 11 works as a concave lens that has a focal distance set according to the refractive index of the liquid crystal polymer 19a determined by the effective value of the AC voltage to be applied to the electrodes sandwiching the liquid crystal polymer 19a and the radius curvature of the refracting lens formed on the surface of the filler 20a on the liquid crystal polymer 19a side. The liquid crystal polymer 19b does not contribute to the action of the lens. In the meantime, for the incoming light, the liquid crystal refracting lens 11 works as a concave lens that has a focal distance set according to the refractive index of the liquid crystal polymer 19b determined by the effective value of the AC voltage to be applied to the electrodes sandwiching the liquid crystal polymer 19b and the radius curvature of the refracting lens formed on the surface of the filler 20b on the liquid crystal polymer 19b side. The liquid crystal polymer 19a does not contribute to the action of the lens. By making the effective value of the AC voltage applied to the electrodes sandwiching the liquid crystal polymer 19a equivalent to the effective value of the AC voltage applied to the electrodes sandwiching the liquid crystal polymer 19b and making the radius curvature of the refracting lens formed on the surface of the filler 20a on the liquid crystal polymer 19a side equivalent to the radius curvature of the refracting lens formed on the surface of the filler 20b on the liquid crystal polymer 19b side, the focal distance of the liquid crystal refracting lens 11 for the outgoing light becomes equivalent to the focal distance of the liquid crystal refracting lens 11 for the incoming light. It is assumed here that the focal distance of the objective lens 5 is 2.35 mm, an object distance at which the spherical aberration is corrected for the thickness 0.1 mm of the protection layer that is the condition of the BD standard is ∞ (magnification is 0), an objective distance at which the spherical aberration is corrected for the thickness 0.6 mm of the protection layer that is the condition of the HD DVD standard and the condition of the DVD standard is 36 mm (magnification is −2.35/36), for example, and an objective distance at which the spherical aberration is corrected for the thickness 1.2 mm of the protection layer that is the condition of the CD standard is 23 mm (magnification is −2.35/23), for example. Further, it is also assumed that the distance from the objective lens 5 to the liquid crystal refracting lens 11 is 2 mm, for example. In this case, the focal distance of the liquid crystal refracting lens 11 may be set as ∞ in order to correct the spherical aberration when the disk 6 is the disk of the BD standard, and the focal distance of the liquid crystal refracting lens 11 may be set as −34 mm when the disk 6 is a disk of the HD DVD standard or the DVD standard. The focal distance of the liquid crystal refracting lens 11 may be set as −21 mm when the disk 6 is the disk of the CD standard.

Provided that both the effective value of the AC voltage to be applied to the electrodes sandwiching the liquid crystal polymer 19a and the effective value of the AC voltage to be applied to the electrodes sandwiching the liquid crystal polymer 19b are “Veff”, and both the refractive index of the liquid crystal polymer 19a for the outgoing light determined accordingly and the refractive index of the liquid crystal polymer 19b for the incoming light are “n”, “n=ne−(Veff−1.5)/2×(ne−no)” applies within a range of “1.5 V<Veff<3.5 V”. Further, it is also assumed that both the radius curvature of the refracting lens formed on the surface of the filler 20a on the liquid crystal polymer 19a side and the radius curvature of the refracting lens formed on the surface of the filler 20b on the liquid crystal polymer 19b side are “21(ne−no)(mm)”. In this case, the focal distance of the liquid crystal refracting lens 11 for the outgoing light and the focal distance of the liquid crystal refracting lens 11 for the incoming light are “−21(ne−no)/(n−no) (mm)”. Therefore, for setting the focal distance of the liquid crystal refracting lens 11 to be “n=no” may be satisfied. For that, “Veff” may be set to 3.5 V. For setting the focal distance of the liquid crystal refracting lens 11 to be −34 mm, “n=ne−13/34×(ne−no)” may be satisfied. For that, “Veff” may be set to 2.26 V. For setting the focal distance of the liquid crystal refracting lens 11 to be −21 mm, “n=ne” may be satisfied. For that, “Veff” may be set to 1.5 V.

When the disk 6 is a disk of the BD standard, “Veff” is set to 3.5 V. In this case, as shown in FIG. 2A, the incident light is transmitted without being affected by the refraction effect at the liquid crystal refracting lens 11. Thereby, the magnification of the objective lens 5 becomes 0, and the spherical aberration is corrected for the thickness 0.1 mm of the protection layer that is the condition of the BD standard. When the disk 6 is a disk of the HD DVD standard or the DVD standard, “Veff” is set to 2.26 V. In this case, as shown in FIG. 2B, the incident light is transmitted by being affected by the refraction effect at the liquid crystal refracting lens 11 as a concave lens having the focal distance of −34 mm. Thereby, the magnification of the objective lens 5 becomes −2.35/36, and the spherical aberration is corrected for the thickness 0.6 mm of the protection layer that is the condition of the HD DVD standard or the DVD standard. When the disk 6 is a disk of the CD standard, “Veff” is set to 1.5 V. In this case, as shown in FIG. 2C, the incident light is transmitted by being affected by the refraction effect at the liquid crystal refracting lens 11 as a concave lens having the focal distance of −21 mm. Thereby, the magnification of the objective lens 5 becomes −2.35/23, and the spherical aberration is corrected for the thickness 1.2 mm of the protection layer that is the condition of the CD standard. As described, the use of the liquid crystal refracting lens 11 makes it possible to change the focal distance continuously within a range of ∞ to −21 mm, so that the spherical aberrations in the outgoing light and the incoming light, which vary depending on the kinds of the disk 6, can be corrected. As a result, it becomes possible to perform recording and reproduction to/from the disks of the BD standard, the HD DVD standard, the DVD standard, and the CD standard in a fine manner.

The liquid crystal aperture control element 16a shown in FIGS. 3A, 3B, and 3C changes the effective numerical aperture of the objective lens 5 in accordance with the kind of the optical recording medium. Specifically, as shown in FIGS. 3A, 3B, and 3C, the liquid crystal aperture control element 16a is in a structure in which a liquid crystal polymer 31a and a filler 32a are sandwiched between a substrate 30a and a substrate 30b, and a liquid crystal polymer 31b and a filler 32b are sandwiched between a substrate 30c and the substrate 30b. A diffraction grating is formed on the surface of the filler 32a on the liquid crystal polymer 31a side, while a diffraction grating is formed on the surface of the filler 32b on the liquid crystal polymer 31b side. Electrodes (not shown) for applying an AC voltage to the liquid crystal polymer 31a are formed on the surfaces of the substrates 30a and 30b on the liquid crystal polymer 31a side, while electrodes (not shown) for applying an AC voltage to the liquid crystal polymer 31b are formed on the surfaces of the substrates 30c and 30b on the liquid crystal polymer 31b side. Arrows in the drawings show the longitudinal direction of the liquid crystal polymers 31a and 31b. The liquid crystal polymers 31a and 31b have a uniaxial refractive index anisotropy whose optical axis direction is the longitudinal direction. Provided that the refractive index for a polarized light component that is in parallel to the longitudinal direction (abnormal light component) is “ne” and the refractive index for a polarized light component that is perpendicular to the longitudinal direction (normal light component) is “no”, “ne” is larger than “no”. In the meantime, the refractive indexes of the fillers 32a and 32b are equivalent to the refractive index of the liquid crystal polymers 31a and 31b for the normal light component. Note here that incident light for the liquid crystal aperture control element 16a in an outgoing path to the disk 6 from the semiconductor laser 1a is linearly polarized light whose polarized direction is in parallel to the paper face of the drawing. The incident light for the liquid crystal aperture control element 16a in an incoming path to the photodetector 9 from the disk 6 is linearly polarized light whose polarized direction is perpendicular to the paper face of the drawing.

When the effective value of the AC voltage applied to the electrodes sandwiching the liquid crystal polymer 31a is 1.5 V, the longitudinal direction of the liquid crystal polymer 19a comes to be in a direction that is almost perpendicular to the optical axis of the incident light and in parallel to the paper face of the drawing. Thus, the refractive index of the liquid crystal polymer 31a for the outgoing light becomes “ne”. When the effective value of the AC voltage applied to the electrodes sandwiching the liquid crystal polymer 31a is 3.5 V, the longitudinal direction of the liquid crystal polymer 31a comes to be in a direction that is almost in parallel to the optical axis of the incident light. Thus, the refractive index of the liquid crystal polymer 31a for the outgoing light becomes “no”. The refractive index of the liquid crystal polymer 31a for the outgoing light becomes “no” regardless of the effective value of the AC voltage applied to the electrodes sandwiching the liquid crystal polymer 31a. In the meantime, when the effective value of the AC voltage applied to the electrodes sandwiching the liquid crystal polymer 31b is 1.5 V, the longitudinal direction of the liquid crystal polymer 31b comes to be in a direction that is almost perpendicular to the optical axis of the incident light and perpendicular to the paper face of the drawing. Thus, the refractive index of the liquid crystal polymer 31b for the incoming light becomes “ne”. When the effective value of the AC voltage applied to the electrodes sandwiching the liquid crystal polymer 31b is 3.5 V, the longitudinal direction of the liquid crystal polymer 31b comes to be in a direction that is almost in parallel to the optical axis of the incident light. Thus, the refractive index of the liquid crystal polymer 31b for the incoming light becomes “no”. The refractive index of the liquid crystal polymer 31b for the outgoing light becomes “no” regardless of the effective value of the AC voltage applied to the electrodes sandwiching the liquid crystal polymer 31b.

As a result, for the outgoing light, the liquid crystal aperture control element 16a works as a diffraction grating that exhibits the diffraction efficiency according to the refractive index of the liquid crystal polymer 31a determined by the effective value of the AC voltage to be applied to the electrodes sandwiching the liquid crystal polymer 31a and the depth of the diffraction grating formed on the surface of the filler 32a on the liquid crystal polymer 31a side. The liquid crystal polymer 31b does not contribute to the action of the diffraction grating. In the meantime, for the incoming light, the liquid crystal aperture control element 16a works as a diffraction grating that exhibits the diffraction efficiency according to the refractive index of the liquid crystal polymer 31b determined by the effective value of the AC voltage to be applied to the electrodes sandwiching the liquid crystal polymer 31b and the depth of the diffraction grating formed on the surface of the filler 32b on the liquid crystal polymer 31b side. The liquid crystal polymer 31a does not contribute to the action of the diffraction grating. By making the effective value of the AC voltage applied to the electrodes sandwiching the liquid crystal polymer 31a equivalent to the effective value of the AC voltage applied to the electrodes sandwiching the liquid crystal polymer 31b and making the depth of the diffraction grating formed on the surface of the filler 32a on the liquid crystal polymer 31a side equivalent to the depth of the diffraction grating formed on the surface of the filler 32b on the liquid crystal polymer 31b side, the diffraction efficiency of the liquid crystal aperture control element 16a for the outgoing light becomes equivalent to the diffraction efficiency of the liquid crystal aperture control element 16a for the incoming light.

Provided that both the effective value of the AC voltage to be applied to the electrodes sandwiching the liquid crystal polymer 31a and the effective value of the AC voltage to be applied to the electrodes sandwiching the liquid crystal polymer 31b are “Veff”, and both the refractive index of the liquid crystal polymer 31a for the outgoing light determined accordingly and the refractive index of the liquid crystal polymer 31b for the incoming light are “n”, “n=ne” applies when “Veff=1.5 V” and “n=no” applies when “Veff=3.5 V”. Further, it is also assumed that both the depth of the diffraction grating formed on the surface of the filler 32a on the liquid crystal polymer 31a side and the depth of the diffraction grating formed on the surface of the filler 32b on the liquid crystal polymer 31b side are “λ/2(ne−no)” (where λ=405 nm). In this case, both the transmittance (efficiency of zeroth-order light) of the liquid crystal aperture control element 16a for the outgoing light and the transmittance (efficiency of zeroth-order light) of the liquid crystal aperture control element 16a for the incoming light are “cos²[π(n−no)/2(ne−no)]”. Therefore, by setting “Veff” to 3.5 V, “n=no” applies and the transmittance of the liquid crystal aperture control element 16a becomes 1. By setting “Veff” to 1.5 V, “n=ne” applies and the transmittance of the liquid crystal aperture control element 16a becomes 0.

As shown in FIG. 4, in the liquid crystal aperture control element 16a, one of the electrodes formed on the surfaces of the substrates 30a, 30b on the liquid crystal polymer 31a side and one of the electrodes formed on the surfaces of the substrates 30c, 30b on the liquid crystal polymer 31b side are divided into four regions of 36a-36d by three concentric circles. This makes it possible to set the effective value of the AC voltage to be applied to the electrodes sandwiching the liquid crystal polymer 31a and the effective value of the AC voltage to be applied to the electrodes sandwiching the liquid crystal polymer 31b independently from each other for the regions 36a-36d. It is defined here that the effective value of the AC voltage to be applied to the electrodes sandwiching the liquid crystal polymer 31a for the regions 36a-36d and the effective value of the AC voltage to be applied to the electrodes sandwiching the liquid crystal polymer 31b for the regions 36a-36d are “Veffa”, “Veffb”, “Veffc”, and “Veffd”, respectively. In the drawing, the circles having the diameter that corresponds to the effective diameter of the objective lens 5 are illustrated with dotted lines.

When the disk 6 is a disk of the BD standard, the effective values of the AC voltages are set as “Veffa=3.5 V”, “Veffb=3.5 V”, “Veffc=3.5 V”, and “Veffd=3.5 V”. In this case, as shown in FIG. 3A, almost all the light out of the incident light passing through any of the regions 36a, 36b, 36c, and 36d is transmitted without being affected by the diffraction effect at the liquid crystal aperture control element 16a. Thereby, the numerical aperture of the objective lens 5 is determined according to the effective diameter of the objective lens 5, and it takes a value of 0.85 that is the condition of the BD standard. When the disk 6 is a disk of the HD DVD standard, the effective values of the AC voltages are set as “Veffa=3.5 V”, “Veffb=3.5 V”, “Veffc=3.5 V”, and “Veffd=1.5 V”. In this case, as shown in FIG. 3B, almost all the light out of the incident light passing through any of the regions 36a, 36b, and 36c is transmitted without being affected by the diffraction effect at the liquid crystal aperture control element 16a, while the light passing through the region 36d is almost completely diffracted by being affected by the diffraction effect at the liquid crystal aperture control element 16a. Thereby, the effective numerical aperture of the objective lens 5 is determined according to the diameter of the circle that is the boundary between the region 36c and the region 36d, and it takes a value of 0.65 that is the condition of the HD DVD standard. When the disk 6 is a disk of the DVD standard, the effective values of the AC voltages are set as “Veffa=3.5 V”, “Veffb=3.5 V”, “Veffc=1.5 V”, and “Veffd=1.5 V”. In this case, as shown in FIG. 3C, almost all the light out of the incident light passing through any of the regions 36a and 36b is transmitted without being affected by the diffraction effect at the liquid crystal aperture control element 16a, while the light passing through the regions 36c and 36d is almost completely diffracted by being affected by the diffraction effect at the liquid crystal aperture control element 16a. Thereby, the effective numerical aperture of the objective lens 5 is determined according to the diameter of the circle that is the boundary between the region 36b and the region 36c, and it takes a value of 0.37 that is preferable for the DVD standard. Through setting the numerical aperture of the objective lens 5 to 0.37, the diameter of the light focusing spot formed on the disk 6 can be made equivalent to that of the case with the condition of the DVD standard in which the wavelength is 650 nm and the numerical aperture of the objective lens is 0.6. When the disk 6 is a disk of the CD standard, the effective values of the AC voltages are set as “Veffa=3.5 V”, “Veffb=1.5 V”, “Veffc=1.5 V”, and “Veffd=1.5 V”. In this case, as shown in FIG. 3D, almost all the light out of the incident light passing through the regions 36a is transmitted without being affected by the diffraction effect at the liquid crystal aperture control element 16a, while the light passing through the regions 36b, 36c, and 36d is almost completely diffracted by being affected by the diffraction effect at the liquid crystal aperture control element 16a. Thereby, the effective numerical aperture of the objective lens 5 is determined according to the diameter of the circle that is the boundary between the region 36a and the region 36b, and it takes a value of 0.23 that is preferable for the CD standard. Through setting the numerical aperture of the objective lens 5 to 0.23, the diameter of the light focusing spot formed on the disk 6 can be made equivalent to that of the case with the condition of the CD standard in which the wavelength is 780 nm and the numerical aperture of the objective lens is 0.45. As described above, the use of the liquid crystal aperture control element 16a makes it possible to control the effective numerical aperture of the objective lens 5 in accordance with the kind of the disk 6.

In the optical head device according to the first exemplary embodiment, the liquid crystal refracting lens 11, the liquid crystal aperture control element 16a, and the quarter wavelength plate 4 are loaded on an actuator (not shown) along with the objective les 5, and those are driven in the optical axis direction and the radial direction of the disk 6. When the absolute value of the focal distance of the liquid crystal refracting lens 11 is small, there is a large spherical aberration generated if the position of the liquid crystal refracting lens 11 is shifted to the optical axis direction with respect to the position of the objective lens 5. If the position of the liquid crystal refracting lens 11 is shifted to the radial direction of the disk 6 with respect to the position of the objective lens 5, a large comma aberration is generated.

However, the position of the liquid crystal refracting lens 11 is not shifted from the position of the objective lens 5 when the liquid crystal refracting lens 11 is driven in the optical axis direction and the radial direction of the disk 6 together with the objective lens 5. Thus, no spherical aberration or the comma aberration is generated. Further, when the effective aperture of the objective lens 5 is reduced by the liquid crystal aperture control element 16a, the shape of the effective numerical aperture of the objective lens 5 is changed if the position of the liquid crystal aperture control element 16a is shifted from the position of the objective lens 5 in the optical axis direction or the radial direction of the disk 6. However, the position of the liquid crystal refracting lens 11 is not shifted from the position of the objective lens 5 when the liquid crystal aperture control element 16a is driven in the optical axis direction and the radial direction of the disk 6 together with the objective lens 5. Thus, there is no change generated in the shape of the effective aperture of the objective lens 5.

Alternatively, in the optical head device according to the first exemplary embodiment, the liquid crystal refracting lens 11, the liquid crystal aperture control element 16a, and the quarter wavelength plate 4 are loaded on an actuator (not shown) separately from the objective lens 5, and those are driven in the optical axis direction and the radial direction of the disk 6 by a same amount as that of the objective lens 5. The position of the liquid crystal refracting lens 11 is not shifted from the position of the objective lens 5 when the liquid crystal refracting lens 11 is driven in the optical axis direction and the radial direction of the disk 6 separately from the objective lens 5 by the same amount as that of the objective lens 5. Thus, no spherical aberration or the comma aberration is generated. Further, when the liquid crystal aperture control element 16a is driven in the optical axis direction and the radial direction of the disk 6 separately from the objective lens 5 by the same amount as that of the objective lens 5, the position of the liquid crystal aperture control element 16a is not shifted from the position of the objective lens 5. Thus, there is no change generated in the shape of the effective aperture of the objective lens 5. In order to drive the liquid crystal refracting lens 11, the liquid crystal aperture control element 16a, and the quarter wavelength plate 4 in the optical axis direction and the radial direction of the disk 6 by the same amount as that of the objective lens 5, the spherical aberration and the comma aberration generated when the position of the liquid crystal refracting lens 11 is shifted from the position of the objective lens 5 in the optical axis direction and the radial direction of the disk 6 may be detected, and the liquid crystal refracting lens 11, the liquid crystal aperture control element 16a, and the quarter wavelength plate 4 may be driven in such a manner that the spherical aberration and the comma aberration become 0. As a method for detecting the spherical aberration and the comma aberration, there is a method depicted in Japanese Unexamined Patent Publication 2003-51130, for example.

It is also possible to employ a form in which the liquid crystal aperture control element 16a that is the aperture control device in the optical head device according to the first exemplary embodiment is replaced with a liquid crystal aperture control element 17a. The liquid crystal aperture control element 17a as the aperture control device changes the effective numerical aperture of the objective lens 5 depending on the kind of the optical recording medium. This will be described in a concretive manner. As shown in FIGS. 5A, 5B, and 5C, the liquid crystal aperture control element 17a is in a structure in which a liquid crystal polymer 34 and a filler 35 are stacked alternately between a substrate 33a and a substrate 33b. Electrodes (not shown) for applying an AC voltage to the liquid crystal polymer 34 are formed on the surfaces of the substrates 33a and 33b on the liquid crystal polymer 34 side. Arrows in the drawings show the longitudinal direction of the liquid crystal polymer 34. The liquid crystal polymer 34 has a uniaxial refractive index anisotropy whose optical axis direction is the longitudinal direction. Provided that the refractive index for a polarized light component that is in parallel to the longitudinal direction (abnormal light component) is “ne” and the refractive index for a polarized light component that is perpendicular to the longitudinal direction (normal light component) is “no”, “ne” is larger than “no”. In the meantime, the refractive indexes of the filler 35 is equivalent to the refractive index of the liquid crystal polymer 34 for the abnormal light component.

When the effective value of the AC voltage to be applied to the electrodes sandwiching the liquid crystal polymer 34 is 0 V, the longitudinal direction of the liquid crystal polymer 34 comes to be in a random direction with respect to the optical axis of the incident light. In this case, the refractive index of the liquid crystal polymer 34 for the incident light is “[(2no²+ne²)/3]^{1/2}”. When the effective value of the AC voltage to be applied to the electrodes sandwiching the liquid crystal polymer 34 is 80 V, the longitudinal direction of the liquid crystal polymer 34 comes to be in a direction that is almost in parallel to the optical axis of the incident light. Thus, the refractive index of the liquid crystal polymer 34 for the outgoing light becomes “no”. As a result, for the outgoing light, the liquid crystal aperture control element 17a works as a reflective diffraction grating that exhibits the diffraction efficiency according to the refractive index of the liquid crystal polymer 34 determined by the effective value of the AC voltage to be applied to the electrodes sandwiching the liquid crystal polymer 34 and the optical thicknesses of each layer of the liquid crystal polymer 34a and the filler 35. Provided that the effective value of the AC voltage to be applied to the electrodes sandwiching the liquid crystal polymer 34 is “Veff” and the refractive index of the liquid crystal polymer 34 for the incident light determined accordingly is “n”, “n=[(2no²+ne²)/3]^{1/2}” applies when “Veff=0”, and “n=no” applies when “Veff=80”. Further, it is also assumed that the optical thicknesses of each layer of the liquid crystal polymer 34 and the filler 35 are “λ/4” (where λ=405 nm). In this case, the transmittance of the liquid crystal aperture control element 17a becomes almost 1 by setting “Veff” to 80 V, and the transmittance of the liquid crystal aperture control element 17a becomes almost 0 by setting “Veff” to 0 V.

As shown in FIG. 4, in the liquid crystal aperture control element 17a, one of the electrodes formed on the surfaces of the substrates 33a and 33b on the liquid crystal polymer 34 side is divided into four regions of 37a-37d by three concentric circles. This makes it possible to set the effective values of the AC voltage to be applied to the electrodes sandwiching the liquid crystal polymer 34 independently from each other for the regions 37a-37d. It is defined here that the effective value of the AC voltage to be applied to the electrodes sandwiching the liquid crystal polymer 34 for the regions 37a-37d are “Veffa”, “Veffb”, “Veffc”, and “Veffd”, respectively. In the drawing, the circles having the diameter that corresponds to the effective diameter of the objective lens 5 are illustrated with dotted lines.

When the disk 6 is a disk of the BD standard, the effective values of the AC voltages are set as “Veffa=80 V”, “Veffb=80 V”, “Veffc=80 V”, and “Veffd=80 V”. In this case, as shown in FIG. 5A, almost all the light out of the incident light passing through any of the regions 37a, 37b, 37c, and 37d is transmitted without being affected by the diffraction effect at the liquid crystal aperture control element 17a. Thereby, the numerical aperture of the objective lens 5 is determined according to the effective diameter of the objective lens 5, and it takes a value of 0.85 that is the condition of the BD standard. When the disk 6 is a disk of the HD DVD standard, the effective values of the AC voltages are set as “Veffa=80 V”, “Veffb=80 V”, “Veffc=80 V”, and “Veffd=0 V”. In this case, as shown in FIG. 5B, almost all the light out of the incident light passing through any of the regions 37a, 37b, and 37c is transmitted without being affected by the diffraction effect at the liquid crystal aperture control element 17a, while the light passing through the region 37d is 1.0 almost completely diffracted by being affected by the diffraction effect at the liquid crystal aperture control element 17a. Thereby, the effective numerical aperture of the objective lens 5 is determined according to the diameter of the circle that is the boundary between the region 37c and the region 37d, and it takes a value of 0.65 that is the condition of the HD DVD standard. When the disk 6 is a disk of the DVD standard, the effective values of the AC voltages are set as “Veffa=80 V”, “Veffb=80 V”, “Veffc=0 V”, and “Veffd=0 V”. In this case, as shown in FIG. 5C, almost all the light out of the incident light passing through any of the regions 37a and 37b is transmitted without being affected by the diffraction effect at the liquid crystal aperture control element 17a, while the light passing through the regions 37c and 37d is almost completely diffracted by being affected by the diffraction effect at the liquid crystal aperture control element 17a. Thereby, the effective numerical aperture of the objective lens 5 is determined according to the diameter of the circle that is the boundary between the region 37b and the region 37c, and it takes a value of 0.37 that is preferable for the DVD standard. Through setting the numerical aperture of the objective lens 5 to 0.37, the diameter of the light focusing spot formed on the disk 6 can be made equivalent to that of the case with the condition of the DVD standard in which the wavelength is 650 nm and the numerical aperture of the objective lens is 0.6. When the disk 6 is a disk of the CD standard, the effective values of the AC voltages are set as “Veffa=80 V”, “Veffb=0 V”, “Veffc=0 V”, and “Veffd=0 V”. In this case, as shown in FIG. 5D, almost all the light out of the incident light passing through the region 37a is transmitted without being affected by the diffraction effect at the liquid crystal aperture control element 17a, while the light passing through the regions 37b, 37c, and 37d is almost completely diffracted by being affected by the diffraction effect at the liquid crystal aperture control element 17a. Thereby, the effective numerical aperture of the objective lens 5 is determined according to the diameter of the circle that is the boundary between the region 37a and the region 37b, and it takes a value of 0.23 that is preferable for the CD standard. Through setting the numerical aperture of the objective lens 5 to 0.23, the diameter of the light focusing spot formed on the disk 6 can be made equivalent to that of the case with the condition of the CD standard in which the wavelength is 780 nm and the numerical aperture of the objective lens is 0.45. As described above, the use of the liquid crystal aperture control element 17a makes it possible to control the effective numerical aperture of the objective lens 5 in accordance with the kinds of the disk 6.

### Second Exemplary Embodiment

An optical head device according to a second exemplary embodiment is a device in which the liquid crystal refracting lens that is a variable focal-point lens which configures the lens system in the first exemplary embodiment is replaced with a liquid crystal refracting lens 12.

As shown in FIGS. 7A, 7B, and 7C, the liquid crystal refracting lens 12 is in a structure in which a liquid crystal polymer 22a is sandwiched between a substrate 21a and a substrate 21b, and a liquid crystal polymer 22b is sandwiched between a substrate 21c and the substrate 21b. Electrodes (not shown) for applying an AC voltage to the liquid crystal polymer 22a are formed on the surfaces of the substrates 21a and 21b on the liquid crystal polymer 22a side, while electrodes (not shown) for applying an AC voltage to the liquid crystal polymer 22b are formed on the surfaces of the substrates 21c and 21b on the liquid crystal polymer 22b side. One of the two electrodes sandwiching the liquid crystal polymer 22a and one of the two electrodes sandwiching the liquid crystal polymer 22b are pattern electrodes, which can change the voltage to be applied to the liquid crystal polymers 22a and 22b from the center part towards the peripheral part. Arrows in the drawings show the longitudinal direction of the liquid crystal polymers 22a and 22b. The liquid crystal polymers 22a and 22b have a uniaxial refractive index anisotropy whose optical axis direction is the longitudinal direction. Provided that the refractive index for a polarized light component that is in parallel to the longitudinal direction (abnormal light component) is “ne” and the refractive index for a polarized light component that is perpendicular to the longitudinal direction (normal light component) is “no”, “ne” is larger than “no”. Note here that incident light for the liquid crystal refracting lens 12 in an outgoing path to the disk 6 from the semiconductor laser 1a is linearly polarized light whose polarized direction is in parallel to the paper face of the drawing. The incident light for the liquid crystal refracting lens 12 in an incoming path to the photodetector 9 from the disk 6 is linearly polarized light whose polarized direction is perpendicular to the paper face of the drawing.

When the effective value of the AC voltage to be applied to the electrodes sandwiching the liquid crystal polymer 22a is 3.5 V in the center part and 1.5 V in the peripheral part (when the effective value of the AC voltage changes from the center part towards the peripheral part), as shown in FIG. 7C, the longitudinal direction of the liquid crystal polymer 22a comes to be in a direction almost in parallel to the optical axis of the incident light in the center part and the longitudinal direction comes to be in a direction almost perpendicular to the optical axis of the incident light and in parallel to the paper face of the drawing in the peripheral part (changes from the center part towards the peripheral part). Thus, the refractive index of the liquid crystal polymer 22a for the outgoing light becomes “no” in the center part and becomes “ne” in the peripheral part, which changes from the center part towards the peripheral part. When the effective value of the AC voltage to be applied to the electrodes sandwiching the liquid crystal polymer 22a is 3.5 V in the center part and 1.5 V-3.5 V in the peripheral part (when the effective value of the AC voltage changes from the center part towards the peripheral part) as shown in FIG. 7B, the longitudinal direction of the liquid crystal polymer 22a comes to be in a direction almost in parallel to the optical axis of the incident light in the center part and the longitudinal direction comes to form, in the peripheral part, a prescribed angle with the optical axis of the incident light within a plane (including the optical axis of the incident light) which is in parallel to the paper face of the drawing (changes from the center part towards the peripheral part). Thus, the refractive index of the liquid crystal polymer 22a for the outgoing light becomes “no” in the center part and becomes an intermediate value between “ne” and “no” in the peripheral part, which changes from the center part towards the peripheral part. As the effective value of the AC voltage in the peripheral part becomes higher, the angle formed by the longitudinal direction of the liquid crystal polymer 22a and the optical axis of the incident light becomes smaller. Thereby, the refractive index of the liquid crystal polymer 22a for the outgoing light becomes close to “no”. Therefore, the refractive index of the liquid crystal polymer 22a for the outgoing light changes almost linearly with respect to the effective value of the AC voltage. When the effective value of the AC voltage to be applied to the electrodes sandwiching the liquid crystal polymer 22a is 3.5 V in the center part as well as in the peripheral part (when the effective value does not change from the center part towards the peripheral part), the longitudinal direction of the liquid crystal polymer 22a comes to be in a direction that is almost in parallel to the optical axis of the incident light in the center part as well as in the peripheral part (there is no change), as shown in FIG. 7A. Thus, the refractive index of the liquid crystal polymer 22a for the outgoing light becomes “no” in the center part as well as in the peripheral part, so that the refractive index does not change from the center towards the peripheral part. The refractive index of the liquid crystal polymer 22a for the incoming light becomes “no” regardless of the effective value of the AC voltage applied to the electrodes sandwiching the liquid crystal polymer 22a.

In the meantime, when the effective value of the AC voltage to be applied to the electrodes sandwiching the liquid crystal polymer 22b is 3.5 V in the center part and 1.5 V in the peripheral part (when the effective value of the AC voltage changes from the center part towards the peripheral part), as shown in FIG. 7C, the longitudinal direction of the liquid crystal polymer 22b comes to be in a direction almost in parallel to the optical axis of the incident light in the center part and the longitudinal direction comes to be in a direction almost perpendicular to the optical axis of the incident light and perpendicular to the paper face of the drawing in the peripheral part (changes from the center part towards the peripheral part). Thus, the refractive index of the liquid crystal polymer 22b for the incoming light becomes “no” in the center part and becomes “ne” in the peripheral part, which changes from the center part towards the peripheral part. When the effective value of the AC voltage to be applied to the electrodes sandwiching the liquid crystal polymer 22b is 3.5 V in the center part and 1.5 V-3.5 V in the peripheral part (when the effective value of the AC voltage changes from the center part towards the peripheral part), as shown in FIG. 7B, the longitudinal direction of the liquid crystal polymer 22b comes to be in a direction almost in parallel to the optical axis of the incident light in the center part and the longitudinal direction comes to form, in the peripheral part, a prescribed angle with the optical axis of the incident light within a plane (including the optical axis of the incident light) which is perpendicular to the paper face of the drawing. Thus, the refractive index of the liquid crystal polymer 22b for the incoming light becomes “no” in the center part and becomes an intermediate value between “ne” and “no” in the peripheral part, which changes from the center part towards the peripheral part. As the effective value of the AC voltage in the peripheral part becomes higher, the angle formed by the longitudinal direction of the liquid crystal polymer 22b and the optical axis of the incident light becomes smaller. Thereby, the refractive index of the liquid crystal polymer 22b for the incoming light becomes close to “no”. Therefore, the refractive index of the liquid crystal polymer 22b for the incoming light changes almost linearly with respect to the effective value of the AC voltage. When the effective value of the AC voltage to be applied to the electrodes sandwiching the liquid crystal polymer 22b is 3.5 V in the center part as well as in the peripheral part (when the effective value does not change from the center part towards the peripheral part), the longitudinal direction of the liquid crystal polymer 22b comes to be in a direction that is almost in parallel to the optical axis of the incident light in the center part as well as in the peripheral part (there is no change from the center part towards the peripheral part), as shown in FIG. 7A. Thus, the refractive index of the liquid crystal polymer 22b for the incoming light becomes “no” in the center part as well as in the peripheral part, so that the refractive index does not change from the center towards the peripheral part. The refractive index of the liquid crystal polymer 22b for the outgoing light becomes “no” regardless of the effective value of the AC voltage applied to the electrodes sandwiching the liquid crystal polymer 22b.

As a result, for the outgoing light, the liquid crystal refracting lens 12 works as a concave lens that has a focal distance set according to the difference between the values (in the center part and the peripheral part) of the refractive index of the liquid crystal polymer 22a determined by the effective value of the AC voltage to be applied to the electrodes sandwiching the liquid crystal polymer 22a. The liquid crystal polymer 22b does not contribute to the action of the lens. In the meantime, for the incoming light, the liquid crystal refracting lens 12 works as a concave lens that has a focal distance set according to the difference between the values (in the center part and the peripheral part) of the refractive index of the liquid crystal polymer 22b determined by the effective value of the AC voltage to be applied to the electrodes sandwiching the liquid crystal polymer 22b. The liquid crystal polymer 22a does not contribute to the action of the lens. By making the effective value of the AC voltage applied to the electrodes sandwiching the liquid crystal polymer 22a equivalent to the effective value of the AC voltage applied to the electrodes sandwiching the liquid crystal polymer 22b in the center part as well as in the peripheral part, the focal distance of the liquid crystal refracting lens 12 for the outgoing light becomes equivalent to the focal distance of the liquid crystal refracting lens 12 for the incoming light.

It is assumed here that the focal distance of the objective lens 5 is 2.35 mm, an object distance at which the spherical aberration is corrected for the thickness 0.1 mm of the protection layer that is the condition of the BD standard is ∞ (magnification is 0), an objective distance at which the spherical aberration is corrected for the thickness 0.6 mm of the protection layer that is the condition of the HD DVD standard and the condition of the DVD standard is 36 mm (magnification is −2.35/36), for example, and an objective distance at which the spherical aberration is corrected for the thickness 1.2 mm of the protection layer that is the condition of the CD standard is 23 mm (magnification is −2.35/23), for example. Further, it is also assumed that the distance from the objective lens 5 to the liquid crystal refracting lens 12 is 2 mm, for example. In this case, the focal distance of the liquid crystal refracting lens 12 may be set as ∞ in order to correct the spherical aberration when the disk 6 is the disk of the BD standard, and the focal distance of the liquid crystal refracting lens 12 may be set as −34 mm when the disk 6 is a disk of the HD DVD standard or the DVD standard. The focal distance of the liquid crystal refracting lens 12 may be set as −21 mm when the disk 6 is the disk of the CD standard.

Provided that both the effective value of the AC voltage to be applied to the electrodes sandwiching the liquid crystal polymer 22a and the effective value of the AC voltage to be applied to the electrodes sandwiching the liquid crystal polymer 22b are “Veff”, and both the refractive index of the liquid crystal polymer 22a for the outgoing light determined accordingly and the refractive index of the liquid crystal polymer 22b for the incoming light are “n”, “n=ne−(Veff−1.5)/2×(ne−no)” applies within a range of “1.5 V<Veff<3.5 V”. Further, it is also assumed that the distance from the optical axis is “r (mm)” and both the thickness of the liquid crystal polymer 22a and the thickness of the liquid crystal polymer 22b are “t (mm)”. In this case, when “n” is changed in a quadratic function manner with respect to “r” so as to satisfy “no−n=r²/(2·f·t)”, the focal distance of the liquid crystal refracting lens 12 for the outgoing light and the focal distance of the liquid crystal refracting lens 12 for the incoming light both become “f (mm)”. When “r” corresponding to the effective diameter of the objective lens 5 is defined as “r0” and “t” is defined as “t=r0²/42 (ne−no) (mm)”, the above expression becomes “n=no−21/f×(ne−no)×(r/r0)²”. Therefore, in order to set the focal distance of the liquid crystal refracting lens 12 to be ∞, “n=no” may be satisfied both in the center part (r=0 mm) and in the peripheral part (r=r0). For that, “Veff” may be set to 3.5 V in both the center part and the peripheral part. In order to set the focal distance of the liquid crystal refracting lens 12 to be −34 mm, “n=no” may be satisfied in the center part and “n=no+21/34×(ne−no)” may be satisfied in the peripheral part. For that, “Veff” may be set to 3.5 V in the center part and may be set to 2.26 V in the peripheral part. In order to set the focal distance of the liquid crystal refracting lens 12 to be −21 mm, “n=no” may be satisfied in the center part and “n=ne” may be satisfied in the peripheral part. For that, “Veff” may be set to 3.5 V in the center part and may be set to 1.5 V in the peripheral part.

When the disk 6 is a disk of the BD standard, “Veff” is set to 3.5 v in the center part as well as in the peripheral part. In this case, as shown in FIG. 7A, the incident light is transmitted without being affected by the refraction effect at the liquid crystal refracting lens 12. Thereby, the magnification of the objective lens 5 becomes 0, and the spherical aberration is corrected for the thickness 0.1 mm of the protection layer that is the condition of the BD standard. When the disk 6 is a disk of the HD DVD standard or the DVD standard, “Veff” is set to 3.5 V in the center part and set to 2.26 V in the peripheral part. In this case, as shown in FIG. 7B, the incident light is transmitted by being affected by the refraction effect at the liquid crystal refracting lens 12 as a concave lens having the focal distance of −34 mm. Thereby, the magnification of the objective lens 5 becomes −2.35/36, and the spherical aberration is corrected for the thickness 0.6 mm of the protection layer that is the condition of the HD DVD standard and the DVD standard. When the disk 6 is a disk of the CD standard, “Veff” is set to 3.5 V in the center part and set to 1.5 V in the peripheral part. In this case, as shown in FIG. 7C, the incident light is transmitted by being affected by the refraction effect at the liquid crystal refracting lens 12 as a concave lens having the focal distance of −21 mm. Thereby, the magnification of the objective lens 5 becomes −2.35/23, and the spherical aberration is corrected for the thickness 1.2 mm of the protection layer that is the condition of the CD standard. As described, the use of the liquid crystal refracting lens 12 makes it possible to change the focal distance continuously within a range of ∞ to −21 mm, so that the spherical aberrations in the outgoing light and the incoming light, which vary depending on the kinds of the disk 6, can be corrected. As a result, it becomes possible to perform recording and reproduction to/from the disks of the BD standard, the HD DVD standard, the DVD standard, and the CD standard in a fine manner.

It is also possible to employ a form in which the liquid crystal aperture control element 16a that is the aperture control device in the optical head device according to the second exemplary embodiment is replaced with the liquid crystal aperture control element 17a.

### Third Exemplary Embodiment

An optical head device according to a third exemplary embodiment is a device in which the liquid crystal refracting lens that is a variable focal-point lens which configures the lens system in the first exemplary embodiment is replaced with a liquid crystal diffraction lens 13a and a liquid crystal refracting lens 14a that is an auxiliary lens system.

As shown in FIGS. 9A, 9B, and 9C, the liquid crystal diffraction lens 13a is in a structure in which a liquid crystal polymer 24a and a filler 25a are sandwiched between a substrate 23a and a substrate 23b, and a liquid crystal polymer 24b and a filler 25b are sandwiched between a substrate 23c and the substrate 23b. A diffraction lens blazed in such a manner that each orbicular zone is protruded in the liquid crystal polymer 24a side is formed on the surface of the filler 25a on the liquid crystal polymer 24a side, while a diffraction lens blazed in such a manner that each orbicular zone is protruded in the liquid crystal polymer 24b side is formed on the surface of the filler 25b on the liquid crystal polymer 24b side. Further, electrodes (not shown) for applying an AC voltage to the liquid crystal polymer 24a are formed on the surfaces of the substrates 23a and 23b on the liquid crystal polymer 24a side, while electrodes (not shown) for applying an AC voltage to the liquid crystal polymer 24b are formed on the surfaces of the substrates 23c and 23b on the liquid crystal polymer 24b side. Arrows in the drawings show the longitudinal direction of the liquid crystal polymers 24a and 24b. The liquid crystal polymers 24a and 24b have a uniaxial refractive index anisotropy whose optical axis direction is the longitudinal direction. Provided that the refractive index for a polarized light component that is in parallel to the longitudinal direction (abnormal light component) is “ne” and the refractive index for a polarized light component that is perpendicular to the longitudinal direction (normal light component) is “no”, “ne” is larger than “no”. In the meantime, the refractive indexes of the fillers 25a and 25b are equivalent to the refractive index of the liquid crystal polymers 24a and 24b for the normal light component. Note here that incident light for the liquid crystal diffraction lens 13a in an outgoing path to the disk 6 from the semiconductor laser 1a is linearly polarized light whose polarized direction is in parallel to the paper face of the drawing. The incident light for the liquid crystal diffraction lens 13a in an incoming path to the photodetector 9 from the disk 6 is linearly polarized light whose polarized direction is perpendicular to the paper face of the drawing.

When the effective value of the AC voltage applied to the electrodes sandwiching the liquid crystal polymer 24a is 1.5 V, the longitudinal direction of the liquid crystal polymer 24a comes to be in a direction that is almost perpendicular to the optical axis of the incident light and in parallel to the paper face of the drawing, as shown in FIG. 9C. Thus, the refractive index of the liquid crystal polymer 24a for the outgoing light becomes “ne”. When the effective value of the AC voltage applied to the electrodes sandwiching the liquid crystal polymer 24a is 1.5 V-3.5 V, the longitudinal direction of the liquid crystal polymer 24a forms a prescribed angle with the optical axis on a plane (including the optical axis of the incident light) which is in parallel to the paper face of the drawing, as shown in FIG. 9B. Thus, the refractive index of the liquid crystal polymer 24a for the outgoing light takes an intermediate value of “ne” and “no”. As the effective value of the AC voltage becomes higher, the angle formed by the longitudinal direction of the liquid crystal polymer 24a and the optical axis of the incident light becomes smaller. Thereby, the refractive index of the liquid crystal polymer 24a for the outgoing light becomes close to “no”. Therefore, the refractive index of the liquid crystal polymer 24a for the outgoing light changes almost linearly with respect to the effective value of the AC voltage. When the effective value of the AC voltage to be applied to the electrodes sandwiching the liquid crystal polymer 24a is 3.5 V, the longitudinal direction of the liquid crystal polymer 24a comes to be in a direction that is almost in parallel to the optical axis of the incident light, as shown in FIG. 9A. Thus, the refractive index of the liquid crystal polymer 24a for the outgoing light becomes “no”. The refractive index of the liquid crystal polymer 24a for the incoming light becomes “no” regardless of the effective value of the AC voltage applied to the electrodes sandwiching the liquid crystal polymer 24a.

In the meantime, when the effective value of the AC voltage to be applied to the electrodes sandwiching the liquid crystal polymer 24b is 1.5 V, the longitudinal direction of the liquid crystal polymer 24b comes to, be in a direction that is almost perpendicular to the optical axis of the incident light and perpendicular to the paper face of the drawing, as shown in FIG. 9C. Thus, the refractive index of the liquid crystal polymer 24b for the incoming light becomes “ne”. When the effective value of the AC voltage applied to the electrodes sandwiching the liquid crystal polymer 24b is 1.5 V-3.5 V, the longitudinal direction of the liquid crystal polymer 24b forms a prescribed angle with the optical axis on a plane (including the optical axis of the incident light) which is perpendicular to the paper face of the drawing, as shown in FIG. 9B. Thus, the refractive index of the liquid crystal polymer 24b for the incoming light takes an intermediate value of “ne” and “no”. As the effective value of the AC voltage becomes higher, the angle formed by the longitudinal direction of the liquid crystal polymer 24b and the optical axis of the incident light becomes smaller. Thereby, the refractive index of the liquid crystal polymer 24b for the incoming light becomes close to “no”. Therefore, the refractive index of the liquid crystal polymer 24b for the incoming light changes almost linearly with respect to the effective value of the AC voltage. When the effective value of the AC voltage to be applied to the electrodes sandwiching the liquid crystal polymer 24b is 3.5 V, the longitudinal direction of the liquid crystal polymer 24b comes to be in a direction that is almost in parallel to the optical axis of the incident light, as shown in FIG. 9A. Thus, the refractive index of the liquid crystal polymer 24b for the incoming light becomes “no”. The refractive index of the liquid crystal polymer 24b for the outgoing light becomes “no” regardless of the effective value of the AC voltage applied to the electrodes sandwiching the liquid crystal polymer 24b.

As a result, for the outgoing light, the liquid crystal diffraction lens 13a works as a concave lens that has a focal distance set according to the grating pitch of the diffraction lens formed on the surface of the filler 25a on the liquid crystal polymer 24a side and the diffraction order of the diffraction lens. The liquid crystal polymer 24b does not contribute to the action of the lens. In the meantime, for the incoming light, the liquid crystal diffraction lens 13a works as a concave lens that has a focal distance set according to the grating pitch of the diffraction lens formed on the surface of the filler 25b on the liquid crystal polymer 24b side and the diffraction order of the diffraction lens. The liquid crystal polymer 24a does not contribute to the action of the lens. By making the grating pitch of the diffraction lens formed on the surface of the filler 25a on the liquid crystal polymer 24a side equivalent to the grating pitch of the diffraction lens formed on the surface of the filler 25b on the liquid crystal polymer 24b side and making the diffraction order of the diffraction lens, formed on the surface of the filler 25a on the liquid crystal polymer 24a side equivalent to the diffraction order of the diffraction lens formed on the surface of the filler 25b on the liquid crystal polymer 24b side, the focal distance of the liquid crystal diffraction lens 13a for the outgoing light becomes equivalent to the focal distance of the liquid crystal diffraction lens 13a for the incoming light.

The structure of the liquid crystal refracting lens 14a is the same as the structure shown in FIG. 7. When the effective value of the AC voltage applied to the electrodes sandwiching the liquid crystal polymer 22a is 3.5 V in the center part and 1.5 V-3.5 V in the peripheral part (when the effective value of the AC voltage changes from the center part towards the peripheral part), and the effective value of the AC voltage applied to the electrodes sandwiching the liquid crystal polymer 22b is 3.5 V in the center part and 1.5 V-3.5 V in the peripheral part (when the effective value of the AC voltage changes from the center part towards the peripheral part), the liquid crystal refracting lens 14a works for the outgoing light as a concave lens hat has a focal distance set according to the difference between the values (in the center part and the peripheral part) of the refractive index of the liquid crystal polymer 22a determined by the effective value of the AC voltage to be applied to the electrodes sandwiching the liquid crystal polymer 22a, and works for the incoming light as a concave lens hat has a focal distance set according to the difference between the values (in the center part and the peripheral part) of the refractive index of the liquid crystal polymer 22b determined by the effective value of the AC voltage to be applied to the electrodes sandwiching the liquid crystal polymer 22b. In the meantime, when the effective value of the AC voltage applied to the electrodes sandwiching the liquid crystal polymer 22a is 1.5 V in the center part and 1.5 V-3.5 V in the peripheral part (when the effective value of the AC voltage changes from the center part towards the peripheral part), and the effective value of the AC voltage applied to the electrodes sandwiching the liquid crystal polymer 22b is 1.5 V in the center part and 1.5 V-3.5 V in the peripheral part (when the effective value of the AC voltage changes from the center part towards the peripheral part), the liquid crystal refracting lens 14a works for the outgoing light as a convex lens hat has a focal distance set according to the difference between the values (in the center part and the peripheral part) of the refractive index of the liquid crystal polymer 22a determined by the effective value of the AC voltage to be applied to the electrodes sandwiching the liquid crystal polymer 22a, and works for the incoming light as a convex lens that has a focal distance set according to the difference between the values (in the center part and the peripheral part) of the refractive index of the liquid crystal polymer 22b determined by the effective value of the AC voltage to be applied to the electrodes sandwiching the liquid crystal polymer 22b. By making the effective value of the AC voltage applied to the electrodes sandwiching the liquid crystal polymer 22a equivalent to the effective value of the AC voltage applied to the electrodes sandwiching the liquid crystal polymer 22b in the center part as well as in the peripheral part, the focal distance of the liquid crystal refracting lens 14a for the outgoing light becomes equivalent to the focal distance of the liquid crystal refracting lens 14a for the incoming light.

It is assumed here that the focal distance of the objective lens 5 is 2.35 mm, an object distance at which the spherical aberration is corrected for the thickness 0.1 mm of the protection layer that is the condition of the BD standard is ∞ (magnification is 0), an objective distance at which the spherical aberration is corrected for the thickness 0.6 mm of the protection layer that is the condition of the HD DVD standard and the condition of the DVD standard is 36 mm (magnification is −2.35/36), for example, and an objective distance at which the spherical aberration is corrected for the thickness 1.2 mm of the protection layer that is the condition of the CD standard is 23 mm (magnification is −2.35/23), for example. Further, it is also assumed that the distance from the objective lens 5 to the liquid crystal diffraction lens 13a is 2 mm, for example. In this case, the focal distance of the liquid crystal diffraction lens 13a may be set as in order to correct the spherical aberration when the disk 6 is the disk of the BD standard, and the focal distance of the liquid crystal diffraction lens 13a may be set as −34 mm when the disk 6 is a disk of the HD DVD standard or the DVD standard. The focal ∞ distance of the liquid crystal diffraction lens 13a may be set as −21 mm when the disk 6 is the disk of the CD standard.

Provided that both the effective value of the AC voltage to be applied to the electrodes sandwiching the liquid crystal polymer 22a and the effective value of the AC voltage to be applied to the electrodes sandwiching the liquid crystal polymer 22b of the liquid crystal diffraction lens 13a are “Veff”, and both the refractive index of the liquid crystal polymer 24a for the outgoing light determined accordingly and the refractive index of the liquid crystal polymer 24b for the incoming light are “n”, “n=ne” applies when “Veff=1.5 V”, “n=(ne+no)/2” applies when “Veff=2.5 V”, and “n=no” applies when Veff=3.5 V″. Further, it is also assumed that both the thickness of the diffraction lens formed on the surface of the filler 25a on the liquid crystal polymer 24a side and the thickness of the diffraction lens formed on the surface of the filler 25b on the liquid crystal polymer 24b side are “2λ/(ne−no)” (where λ=405 nm). In this case, both the phase depth of the diffraction lens formed on the surface of the filler 25a on the liquid crystal polymer 24a side and the phase depth of the diffraction lens formed on the surface of the filler 25b on the liquid crystal polymer 24b side are “4π(n−no)/(ne−no)]”. Thus, the phase depth becomes 0 when “n=no” applies, and both the transmittance (efficiency of zeroth-order light) of the liquid crystal diffraction lens 13a for the outgoing light and the transmittance (efficiency of zeroth-order light) of the liquid crystal diffraction lens 13a for the incoming light become 1. The phase depth becomes 2π when “n=(ne+no)/2” applies, and both the first-order diffraction efficiency for the outgoing light and the first-order diffraction efficiency for the incoming light become 1. The phase depth becomes 4π when “n=ne” applies, and both the second-order diffraction efficiency for the outgoing light and the second-order diffraction efficiency for the incoming light become 1. Furthermore, it is also assumed that the distance from the optical axis is “r (mm)” and both the grating pitch of the diffraction lens formed on the filler 25a on the liquid crystal polymer 24a side and the grating pitch of the diffraction lens formed on the filler 25b on the liquid crystal polymer 24b side are “p (nm)”. In this case, when “p” is changed with respect to “r” to satisfy “p=−f·λ/r (where λ=405 nm)”, the focal distance of the liquid crystal diffraction lens 13a for the outgoing transmission light (zeroth-order light) and the focal distance of the liquid crystal diffraction lens 13a for the incoming transmission light (zeroth-order light) both become ∞. Further, the focal distance for the outgoing first-order diffraction light and the focal distance for the incoming first-order diffraction light both become “f”, and the focal distance for the outgoing second-order diffraction light and the focal distance for the incoming second-order diffraction light both become “f/2”. It is assumed here that “f=−38.8 mm”. Thus, “n=no” applies when “Veff” is set to 3.5 V, and the incident light for the liquid crystal diffraction lens 13a becomes transmission light (zeroth-order light). Therefore, the focal distance of the liquid crystal diffraction lens 13a becomes ∞. Further, “n=(ne+no)/2” applies when “Veff” is set to 2.5 V, and the incident light for the liquid crystal diffraction lens 13a becomes the first-order diffraction light. Therefore, the focal distance of the liquid crystal diffraction lens 13a becomes −38.8 mm. Furthermore, “n=ne” applies when Veff is set to 1.5 V, and the incident light for the liquid crystal diffraction lens 13a becomes the second-order diffraction light. Therefore, the focal distance of the liquid crystal diffraction lens 13a becomes −19.4 mm.

When the disk 6 is a disk of the BD standard, “Veff” is set to 3.5 V. In this case, as shown in FIG. 9A, the incident light is transmitted as transmission light (zeroth-order light) without being affected by the diffraction effect at the liquid crystal diffraction lens 13a. Thereby, the magnification of the objective lens 5 becomes 0. In order to correct the spherical aberration for the thickness 0.1 mm of the protection layer that is the condition of the BD standard, the position of the objective point for the liquid crystal diffraction lens 13a may be set as ∞ since the position of the image point for the liquid crystal diffraction lens 13a is ∞. When the disk 6 is a disk of the HD DVD standard or the DVD standard, “Veff” is set to 2.5 V. In this case, as shown in FIG. 9B, the incident light is diffracted as the first-order diffraction light by being affected by the diffraction effect at the liquid crystal diffraction lens 13a. Thereby, the magnification of the objective lens 5 becomes −2.35/36. In order to correct the spherical aberration for the thickness 0.6 mm of the protection layer that is the condition of the HD DVD standard or the DVD standard, the position of the objective point for the liquid crystal diffraction lens 13a may be set as 274.8 mm when the thickness of the liquid crystal diffraction lens 13a is ignored for simplification, since the position of the image point for the liquid crystal diffraction lens 13a is −34 mm and the focal distance of the liquid crystal diffraction lens 13a is −38.8 mm. When the disk 6 is a disk of the CD standard, “Veff” is set to 1.5 V. In this case, as shown in FIG. 9C, the incident light is diffracted as the second-order diffraction light by being affected by the diffraction effect at the liquid crystal diffraction lens 13a. Thereby, the magnification of the objective lens 5 becomes −2.35/23. In order to correct the spherical aberration for the thickness 1.2 mm of the protection layer that is the condition of the CD standard, the position of the objective point for the liquid crystal diffraction lens 13a may be set as −254.6 mm when the thickness of the liquid crystal diffraction lens 13a is ignored for simplification, since the position of the image point for the liquid crystal diffraction lens 13a is −21 mm and the focal distance of the liquid crystal diffraction lens 13a is −19.4 mm. Furthermore, it is so defined that the distance from the liquid crystal diffraction lens 13a to the liquid crystal refracting lens 14a is 10 mm, for example. In this case, in order to correct the spherical aberration, the focal distance of the liquid crystal refracting lens 14a may be set as ∞ when the disk 6 is of the BD standard, the focal distance of the liquid crystal refracting lens 14a may be set as −264.8 mm when the disk 6 is of the HD DVD standard or the DVD standard, and the focal distance of the liquid crystal refracting lens 14a may be set as 264.6 mm when the disk 6 is of the CD standard.

Provided that both the effective value of the AC voltage to be applied to the electrodes sandwiching the liquid crystal polymer 22a and the effective value of the AC voltage to be applied to the electrodes sandwiching the liquid crystal polymer 22b of the liquid crystal refracting lens 14a are “Veff”, and both the refractive index of the liquid crystal polymer 22a for the outgoing light determined accordingly and the refractive index of the liquid crystal polymer 22b for the incoming light are “n”, “n=ne−(Veff−1.5)/2×(ne−no)” applies within a range of “1.5 V<Veff<3.5 V”. Further, it is also assumed that the distance from the optical axis is “r (mm)” and both the thickness of the liquid crystal polymer 22a and the thickness of the liquid crystal polymer 22b are “t (mm)”. In this case, when “n” is changed in a quadratic function manner with respect to “r” so as to satisfy “no−n=r²/(2·f·t)” or “ne−n=r²/(2·f·t)”, the focal distance of the liquid crystal refracting lens 14a for the outgoing light and the focal distance of the liquid crystal refracting lens 14a for the incoming light both become “f (mm)”. When the left side is “no−n”, “f” takes a negative value. Thus, the liquid crystal refracting lens 14a becomes a concave lens. When the left side is “ne−n”, “f” takes a positive value. Thus, the liquid crystal refracting lens 14a becomes a convex lens. When “r” corresponding to the effective diameter of the objective lens 5 is defined as “r0” and “t” is defined as “t=r0²/529.2(ne−no) (mm)”, the above expression becomes “n=no−264.6/f×(ne−no)×(r/r0)²” or “n=ne−264.6/f×(ne−no)×(r/r0)²”. Therefore, in order to set the focal distance of the liquid crystal refracting lens 14a to be ∞, “n=no” or “n=ne” may be satisfied both in the center part (r=0 mm) and in the peripheral part (r=r0). For that, “Veff” may be set to 3.5 V in both the center part and the peripheral part or “Veff” may be set to 1.5 V in both the center part and the peripheral part. In order to set the focal distance of the liquid crystal refracting lens 14a to be −264.8 mm, “n=no” may be satisfied in the center part and “n=no+264.6/264.8×(ne−no)” may be satisfied in the peripheral part. For that, “Veff” may be set to 3.5 V in the center part and may be set to 1.5 V in the peripheral part. In order to set the focal distance of the liquid crystal refracting lens 14a to be 264.6 mm, “n=ne” may be satisfied in the center part and “n=no” may be satisfied in the peripheral part. For that, “Veff” may be set to 1.5 V in the center part and may be set to 3.5 V in the peripheral part.

When the disk 6 is a disk of the BD standard, “Veff” is set to 3.5 V in the center part as well as in the peripheral part or set to 1.5 V in the center part as well as in the peripheral part. In this case, the incident light is transmitted without being affected by the diffraction effect at the liquid crystal refracting lens 14a. Thereby, the position of the object point for the liquid crystal diffraction lens 13a becomes ∞, and the spherical aberration is corrected for the thickness 0.1 mm of the protection layer that is the condition of the BD standard. When the disk 6 is a disk of the HD DVD standard or the DVD standard, “Veff” is set to 3.5 V in the center part and set to 1.5 V in the peripheral part. In this case, the incident light is transmitted by being affected by the refraction effect at the liquid crystal refracting lens 14a as a concave lens having the focal distance of −264.8 mm. Thereby, the position of the object point for the liquid crystal diffraction lens 13a becomes 274.8 mm, and the spherical aberration is corrected for the thickness 0.6 mm of the protection layer that is the condition of the HD DVD standard or the DVD standard. When the disk 6 is a disk of the CD standard, “Veff” is set to 1.5 V in the center part and set to 3.5 V in the peripheral part. In this case, the incident light is transmitted by being affected by the refraction effect at the liquid crystal refracting lens 14a as a convex lens having the focal distance of 264.6 mm. Thereby, the position of the object point for the liquid crystal diffraction lens 13a becomes −254.6 mm, and the spherical aberration is corrected for the thickness 1.2 mm of the protection layer that is the condition of the CD standard. As described, the use of the liquid crystal refracting lens 14a makes it possible to change the focal distance continuously within a range of ∞ to ±264.6 mm, so that the spherical aberrations in the outgoing light and the incoming light, which vary depending on the kinds of the disk 6, can be corrected. As a result, it becomes possible to perform recording and reproduction to/from the disks of the BD standard, the HD DVD standard, the DVD standard, and the CD standard in a fine manner.

In the optical head device according to the third exemplary embodiment, the liquid crystal diffraction lens 13a, the liquid crystal aperture control element 16a, and the quarter wavelength plate 4 are loaded on an actuator (not shown) along with the objective lens 5, and those are driven in the optical axis direction and the radial direction of the disk 6. When the absolute value of the focal distance of the liquid crystal diffraction lens 13a is small, there is a large spherical aberration generated if the position of the liquid crystal diffraction lens 13a is shifted to the optical axis direction with respect to the position of the objective lens 5. If the position of the liquid crystal diffraction lens 13a is shifted to the radial direction of the disk 6 with respect to the position of the objective lens 5, a large comma aberration is generated. However, the position of the liquid crystal diffraction lens 13a is not shifted from the position of the objective lens 5 when the liquid crystal diffraction lens 13a is driven in the optical axis direction and the radial direction of the disk 6 together with the objective lens 5. Thus, no spherical aberration or the comma aberration is generated.

Alternatively, in the optical head device according to the third exemplary embodiment, the liquid crystal diffraction lens 13a, the liquid crystal aperture control element 16a, and the quarter wavelength plate 4 are loaded on an actuator (not shown) separately from the objective lens 5, and those are driven in the optical axis direction and the radial direction of the disk 6 by a same amount as that of the objective lens 5. The position of the liquid crystal diffraction lens 13a is not shifted from the position of the objective lens 5 when the liquid crystal diffraction lens 13a is driven in the optical axis direction and the radial direction of the disk 6 separately from the objective lens 5 by the same amount as that of the objective lens 5. Thus, no spherical aberration or the comma aberration is generated.

In the optical head device according to the third exemplary embodiment, the liquid crystal refracting lens 14a is not driven in the optical axis direction and in the radial direction of the disk 6. The absolute value of the focal distance of the liquid crystal refracting lens 14a is large. Thus, even when the liquid crystal refractive lens 14a is not driven in the optical axis direction and in the radial direction of the disk 6 and the position of the liquid crystal refracting lens 14a is shifted in the optical axis direction with respect to the position of the objective lens 5, almost no spherical aberration is generated. Also, there is almost no comma aberration generated even when the position of the liquid crystal refracting lens 14a is shifted in the radial direction of the disk 6 with respect to the position of the objective lens 5.

Regarding the optical head device according to the third exemplary embodiment, it is also possible to employ a form in which the liquid crystal refracting lens 14a as an auxiliary lens system of the third exemplary embodiment is replaced with an expander lens that is configured with a concave lens and a convex lens. Since it is unnecessary to drive the liquid crystal refracting lens 14a in the optical axis direction and the radial direction of the disk 6, the liquid crystal refracting lens 14a can be replaced with the expander lens which is difficult to be driven in the optical axis direction and the radial direction of the disk 6 because it is large in size. When the disk 6 is a disk of the BD standard, the space between the concave lens and the convex lens is controlled so that light making incident on the concave lens as parallel light exits from the convex lens as the parallel light, and the position of the object point for the liquid crystal diffraction lens 13a becomes ∞. When the disk 6 is a disk of the HD DVD standard or the DVD standard, the space between the concave lens and the convex lens is controlled so that light making incident on the concave lens as parallel light exits from the convex lens as divergent light of proper divergent angles, and the position of the object point for the liquid crystal diffraction lens 13a becomes 274.8 mm. When the disk 6 is a disk of the CD standard, the space between the concave lens and the convex lens is controlled so that light making incident on the concave lens as parallel light exits from the convex lens as convergent light with proper convergent angles, and the position of the object point for the liquid crystal diffraction lens 13a becomes −254.6 mm. A motor or a piezoelectric element is used as a device for changing the space between the concave lens and the convex lens.

As the optical head device according to the third exemplary embodiment, it is also possible to employ a form in which the liquid crystal aperture control element 16a as the aperture control device of the third exemplary embodiment is replaced with the liquid crystal aperture control element 17a.

In the optical head device according to the first exemplary embodiment, the radius curvature of the refracting lens (liquid crystal refracting lens 11) formed on the surface of the filler 20a on the liquid crystal polymer 19a side and the radius curvature of the refracting lens formed on the surface of the filler 20b on the liquid crystal polymer 19b side are both “21(ne−no) (mm)”. Further, it is also assumed that the distance from the optical axis is “r (mm)”, and “r” corresponding to the effective diameter of the objective lens 5 is “r0”. Provided that “no=1.52”, “ne=1.77”, and “r0=2 mm”, the radius curvature of the refracting lens is 5.25 mm, and both the difference in the thicknesses of the peripheral part and the center part of the liquid crystal polymer 19a as well as the difference in the thicknesses of the peripheral part and the center part of the liquid crystal polymer 19b are 0.396 mm. That is, both the minimum value of the thickness in the peripheral part of the liquid crystal polymer 19a and the minimum value of the thickness in the peripheral part of the liquid crystal polymer 19b are as large as 0.396 mm. Therefore, the time required for changing the focal distance of the liquid crystal refracting lens 11 is as long as several seconds. Further, in the second exemplary embodiment of the optical head device according to the present invention, the thickness of the liquid crystal polymer 22a and the thickness of the liquid crystal polymer 22b in the liquid crystal refracting lens 12 are both “r0²/42(ne−no) (mm)”. Provided that “no=1.52”, “ne=1.77”, and “r0=2 mm”, the thickness of the liquid crystal polymer 22a and the thickness of the liquid crystal polymer 22b are both as large as 0.381 mm. Therefore, the time required for changing the focal distance of the liquid crystal refracting lens 11 is as long as several seconds.

In the meantime, in the optical head device according to the first exemplary embodiment, the thickness of the diffraction lens (liquid crystal diffraction lens 13) formed on the surface of the filler 25a on the liquid crystal polymer 24a side and the thickness of the diffraction lens formed on the surface of the filler 25b on the liquid crystal polymer 24b side are both “2λ(ne−no) (where λ=950 nm)”. Provided that “no=1.52” and “ne=1.77”, the thickness of the diffraction lens is 3.24 μm. That is, both the minimum value of the thickness in the peripheral part of the liquid crystal polymer 24a and the minimum value of the thickness in the peripheral part of the liquid crystal polymer 24b are as small as 3.24 μm. Therefore, the time required for changing the focal distance of the liquid crystal diffraction lens 13 is as short as several tens milliseconds. Further, the thickness of the liquid crystal polymer 22a and the thickness of the liquid crystal polymer 22b in the liquid crystal refracting lens 14a are both “r0²/529.2 (ne−no) (mm)”. Provided that “no=1.52”, “ne=1.77”, and “r0=2 mm”, the thickness of the liquid crystal polymer 22a and the thickness of the liquid crystal polymer 22b are both as small as 30.2 μm. Therefore, the time required for changing the focal distance of the liquid crystal refracting lens 14a is as short as several hundreds milliseconds. Further, in the exemplary embodiment in which the liquid crystal refracting lens 14a of the optical head device according to the third exemplary embodiment is replaced with the expander lens, the time required for changing the focal distance of the expander lens is as short as several tens milliseconds-several hundreds milliseconds.

As described, when the variable focal-point lens is formed with the refractive liquid crystal lens that is capable of continuously changing the focal distance in a wide range, the time required for changing the focal distance becomes long. In the meantime, when the variable focal-point lens is formed with the diffractive liquid crystal lens that is capable of discretely changing the focal distance in a wide range, and a refractive lens liquid crystal lens or the expander lens, which is capable of continuously changing the focal distance in a narrow range, the time required for changing the focal distance becomes short.

### Fourth Exemplary Embodiment

An optical head device according to a fourth exemplary embodiment is a device in which the liquid crystal refracting lens 11 as the variable focal-point lens which configures the lens system in the first exemplary embodiment is replaced with a liquid lens 15.

As shown in FIGS. 10A, 10B, and 10C, the liquid lens 15 is in a structure in which water 28 having conductivity and oil 29 having an insulating property are sandwiched between a substrate 26a and a substrate 26b. Electrodes 27a and 27b for applying AC voltage to the water 28 are provided in the peripheral part of the substrate 26a and the substrate 26b, respectively. The electrode 27a is in contact with the water 28, and the electrode 27b is in contact with the water 28 and the oil 29. Provided that the refractive index of the water 28 is “nw” and the refractive index of the oil 29 is “no”, “no” is larger than “nw”.

When the effective value of the AC voltage to be applied between the electrode 27a and the electrode 27b is set to 0 V, as shown in FIG. 10A, the area of the part of the electrode 27b in contact with the water 28 is small. Thus, the water 28 comes to be thin in the peripheral part and thick in the center part, and a refracting lens with a small radius curvature protruded on the oil 29 side is formed in the interface of the water 28 and the oil 29. When the effective value of the AC voltage to be applied between the electrode 27a and the electrode 27b is increased, as shown in FIG. 10B, the area of the part of the electrode 27b in contact with the water 28 is increased. Therefore, the difference between the thickness of the water 28 in the peripheral part and in the center part becomes small, and the radius curvature of the refracting lens formed in the interface of the water 28 and the oil 29 becomes large. The reciprocal of the radius curvature of the refracting lens formed in the interface of the water 28 and the oil 29 changes almost linearly with respect to the effective value of the AC voltage applied between the electrode 27a and the electrode 27b. When the effective value of the AC voltage applied between the electrode 27a and the electrode 27b is further increased to 40 V, as shown in FIG. 10A, the area of the part of the electrode 27b in contact with the water 28 is increased further. Therefore, the thickness of the water 28 in the peripheral part and the thickness in the center part become equivalent, and the radius curvature of the refracting lens formed in the interface of the water 28 and the oil 29 becomes ∞. As a result, the liquid lens 15 works as a concave lens having the focal distance that depends on the radius curvature of the refracting lens formed in the interface of the water 28 and the oil 29, which is determined according to the effective value of the AC voltage applied between the electrode 27a and the electrode 27b.

It is assumed here that the focal distance of the objective lens 5 is 2.35 mm, an object distance at which the spherical aberration is corrected for the thickness 0.1 mm of the protection layer that is the condition of the BD standard is ∞ (magnification is 0), an objective distance at which the spherical aberration is corrected for the thickness 0.6 mm of the protection layer that is the condition of the HD DVD standard and the condition of the DVD standard is 36 mm (magnification is −2.35/36), for example, and an objective distance at which the spherical aberration is corrected for the thickness 1.2 mm of the protection layer that is the condition of the CD standard is 23 mm (magnification is −2.35/23), for example. Further, it is also assumed that the distance from the objective lens 5 to the liquid lens 15 is 2 mm, for example. In this case, the focal distance of the liquid lens 15 may be set as ∞ in order to correct the spherical aberration when the disk 6 is the disk of the BD standard, and the focal distance of the liquid lens 15 may be set as −34 mm when the disk 6 is a 1.5 disk of the HD DVD standard or the DVD standard. The focal distance of the liquid lens 15 may be set as −21 mm when the disk 6 is the disk of the CD standard.

When it is assumed that the effective value of the AC voltage to be applied between the electrode 27a and the electrode 27b is “Veff” and the radius curvature of the refracting lens formed in the interface of the water 28 and the oil 29 determined thereby is “R”, “R=840 (no−nw)/(40−Veff) (mm)” applies. In this case, the focal distance of the liquid lens 15 becomes “−R/(no−nw) (mm)”. Therefore, in order to set the focal distance of the liquid lens 15 as ∞, “R” may be set to ∞. For that, “Veff” may be set to 40 V. In order to set the focal distance of the liquid lens 15 as −34 mm, “R” may be set to “34(no−nw) (mm)”. For that, “Veff” may be set to 15.3 V. In order to set the focal distance of the liquid lens 15 as −21 mm, “R” may be set to “21(no−nw) (mm)”. For that, “Veff” may be set to 0 V.

When the disk 6 is a disk of the BD standard, “Veff” is set to 40 V. In this case, as shown in FIG. 10A, the incident light is transmitted without being affected by the refraction effect at the liquid lens 15. Thereby, the magnification of the objective lens 5 becomes 0, and the spherical aberration is corrected for the thickness 0.1 mm of the protection layer that is the condition of the BD standard. When the disk 6 is a disk of the HD DVD standard 1.0 or the DVD standard, “Veff” is set to 15.3 V. In this case, as shown in FIG. 10B, the incident light is transmitted by being affected by the refraction effect at the liquid lens 15 as a concave lens having the focal distance of −34 mm. Thereby, the magnification of the objective lens 5 becomes −2.35/36, and the spherical aberration is corrected for the thickness 0.6 mm of the protection layer that is the condition of the HD DVD standard or the DVD standard. When the disk 6 is a disk of the CD standard, “Veff” is set to 0 V. In this case, as shown in FIG. 10C, the incident light is transmitted by being affected by the refraction effect at the liquid lens 15 as a concave lens having the focal distance of −21 mm. Thereby, the magnification of the objective lens 5 becomes −2.35/23, and the spherical aberration is corrected for the thickness 1.2 mm of the protection layer that is the condition of the CD standard. As described, the use of the liquid lens 15 makes it possible to change the focal distance continuously within a range of to −21 mm, so that the spherical aberrations which vary depending on the kind of the disk 6 can be corrected. As a result, it becomes possible to perform recording and reproduction to/from the disks of the BD standard, the HD DVD standard, the DVD standard, and the CD standard in a fine manner. In the optical head device according to the fourth exemplary embodiment, the liquid lens 15, the liquid crystal aperture control element 16a, and the quarter wavelength plate 4 are loaded on an actuator (not shown) along with the objective les 5, and those are driven in the optical axis direction and the radial direction of the disk 6. When the absolute value of the focal distance of the liquid lens 15 is small, there is a large spherical aberration generated if the position of the liquid lens 15 is shifted to the optical axis direction with respect to the position of the objective lens 5. If the position of the liquid lens 15 is shifted to the radial direction of the disk 6 with respect to the position of the objective lens 5, a large comma aberration is generated. However, the position of the liquid lens 15 is not shifted from the position of the objective lens 5 when the liquid lens 15 is driven in the optical axis direction and the radial direction of the disk 6 together with the objective lens 5. Thus, no spherical aberration or the comma aberration is generated.

Alternatively, in the optical head device according to the fourth exemplary embodiment, the liquid lens 15, the liquid crystal aperture control element 16a, and the quarter wavelength plate 4 are loaded on an actuator (not shown) separately from the objective lens 5, and those are driven in the optical axis direction and the radial direction of the disk 6 by a same amount as that of the objective lens 5. The position of the liquid lens 15 is not shifted from the position of the objective lens 5 when the liquid lens 15 is driven in the optical axis direction and the radial direction of the disk 6 separately from the objective lens 5 by the same amount as that of the objective lens 5. Thus, no spherical aberration or the comma aberration is generated.

It is also possible to employ a form in which the liquid crystal aperture control element 16a as the aperture control device of the optical head device according to the fourth exemplary embodiment is replaced with the liquid crystal aperture control element 17a.

In the optical head device according to the fourth exemplary embodiment, the time required for changing the focal distance of the liquid lens 15 is as short as several tens milliseconds-several hundreds milliseconds. As described, when the variable focal-point lens is formed with the liquid lens that is capable of continuously changing the focal distance in a wide range, the time required fro changing the focal distance becomes short.

### Fifth Exemplary Embodiment

FIG. 11 shows an optical head device according to a fifth exemplary embodiment. The wavelengths of light emitted from semiconductor lasers 1a, 1b, and 1c as light sources is 405 nm, 650 nm, and 780 nm, respectively. The emission light from the semiconductor laser 1a is converted from divergent light into parallel light at a collimator lens 2a. Almost all the parallel light transmits through an interference filter 10a, and makes incident as P-polarized light on a polarizing beam splitter 3 as a light separating device and transmits therethrough. Then, the light passes through a liquid crystal refracting lens 11 that is a variable focal-point lens which configures a lens system and a liquid crystal aperture control element 16b that is an aperture control device, and it is converted from the linearly polarized light into circularly polarized light by the quarter wavelength plate 4. The light is then condensed by an objective lens 5 onto a disk 6 that is an optical recording medium. The reflected light from the disk 6 passes the objective lens 5 in an inverse direction, which is converted by the quarter wavelength plate 4 from circularly polarized light into linearly polarized light whose polarizing direction is orthogonal to the outgoing light. The linearly polarized light passes the liquid crystal aperture control element 16b and the liquid crystal refracting lens 11 in an inverse direction, and makes incident on the polarizing beam splitter 3 as S-polarized light. Almost all the light is reflected there, the reflected light passes through a cylindrical lens 7 and a convex lens 8, and it is received by a photodetector 9. The emission light from the semiconductor laser 1b is converted from divergent light into parallel light at a collimator lens 2b. Almost all the parallel light is reflected at an interference filter 10b, and almost all the parallel light is reflected at the interference filter 10a. The reflected light makes incident as P-polarized light on the polarizing beam splitter 3 as a light separating device, and transmits therethrough. Then, the light passes through the liquid crystal refracting lens 11 that is a variable focal-point lens which configures the lens system and the liquid crystal aperture control element 16b that is the aperture control device, and it is converted from the linearly polarized light into circularly polarized light by the quarter wavelength plate 4. The light is then converged by the objective lens 5 onto the disk 6 that is the optical recording medium. The reflected light from the disk 6 passes the objective lens 5 in an inverse direction, which is converted by the quarter wavelength plate 4 from circularly polarized light into linearly polarized light whose polarizing direction is orthogonal to the outgoing light. The linearly polarized light passes the liquid crystal aperture control element 16b and the liquid crystal refracting lens 11 in an inverse direction, and makes incident on the polarizing beam splitter 3 as S-polarized light. Almost all the light is reflected there, the reflected light passes through the cylindrical lens 7 and the convex lens 8, and it is received by the photodetector 9. The emission light from the semiconductor laser 1c is converted from divergent light into parallel light at a collimator lens 2b. Almost all the parallel light transmits through the interference filter 10b, and almost all the light is reflected at the interference filter 10a. The light makes incident as P-polarized light on the polarizing beam splitter 3 as a light separating device and transmits therethrough. Then, the light passes through the liquid crystal refracting lens 11 that is a variable focal-point lens which configures the lens system and the liquid crystal aperture control element 16b that is the aperture control device, and it is converted from the linearly polarized light into circularly polarized light by the quarter wavelength plate 4. The light is then condensed by the objective lens 5 onto the disk 6 that is the optical recording medium. The reflected light from the disk 6 passes the objective lens 5 in an inverse direction, which is converted by the quarter wavelength plate 4 from circularly polarized light into linearly polarized light whose polarizing direction is orthogonal to the outgoing light. The linearly polarized light passes the liquid crystal aperture control element 16b and the liquid crystal refracting lens 11 in an inverse direction, and makes incident on the polarizing beam splitter 3 as S-polarized light. Almost all the light is reflected there, the reflected light passes through the cylindrical lens 7 and the convex lens 8, and it is received by the photodetector 9. In this exemplary embodiment, the light of 405 nm wavelength is used for performing recording and reproduction of information to/from the disks of the BD standard and the HD DVD standard, the light of 650 nm wavelength is used for performing recording and reproduction of information to/from the disks of the DVD standard, and the light of 780 nm wavelength is used for performing recording and reproduction of information to/from the disks of the CD standard.

A DVD-R that is a kind of the DVD-standard disk can achieve a high reflectance with the wavelength of 650 nm but cannot achieve a high reflectance with the wavelength of 405 nm. Further, a CD-R that is a kind of the CD-standard disk can achieve a high reflectance with the wavelength of 780 nm but cannot achieve a high reflectance with the wavelength of 405 nm. In this exemplary embodiment, light of the 650 nm wavelength is used for performing recording and reproduction of information to/from the disks of the DVD standard, and light of the 780 nm wavelength is used for performing recording and reproduction of information to/from the disks of the CD standard. Therefore, it is possible to achieve the high reflectance for the DVD-R and the CD-R, so that recording and reproduction can be performed stably.

The actions of the liquid crystal refracting lens 11 according to the fifth exemplary embodiment are the same as those described in the first exemplary embodiment.

The structure of the liquid crystal aperture control element 16b is the same as the structure shown in FIG. 3. Provided that both the effective value of the AC voltage to be applied to the electrodes sandwiching the liquid crystal polymer 31a and the effective value of the AC voltage to be applied to the electrodes sandwiching the liquid crystal polymer 31b are “Veff”, and both the refractive index of the liquid crystal polymer 31a for the outgoing light determined accordingly and the refractive index of the liquid crystal polymer 31b for the incoming light are “n”, “n=ne−(Veff−1.5)/2×(ne−no)” applies when “Veff” is within a range of “1.5 V<Veff<3.5 V”. Further, it is also assumed that both the depth of the diffraction grating formed on the surface of the filler 32a on the liquid crystal polymer 31a side and the depth of the diffraction grating formed on the surface of the filler 32b on the liquid crystal polymer 31b side are “λ/2(ne−no)” (where λ=780 nm). In this case, both the transmittance (efficiency of zeroth-order light) of the liquid crystal aperture control element 16a for the outgoing light and the transmittance (efficiency of zeroth-order light) of the liquid crystal aperture control element 16a for the incoming light are “cos² [780/405×π(n−no)/2(ne−no)]” for the light of 405 nm wavelength, “cos² [780/650×π(n−no)/2(ne−no)]” for the light of 650 nm wavelength, and “cos² [π(n−no)/2(ne−no)]” for the light of 780 nm wavelength. Therefore, by setting “Veff” to 3.5 V for the light of 405 nm wavelength, “n=no” applies and the transmittance of the liquid crystal aperture control element 16a becomes 1. By setting “Veff” to 2.46 V, “n=ne−375/780×(ne−no)” applies and the transmittance of the liquid crystal aperture control element 16a becomes 0. By setting “Veff” to 3.5 V for the light of 650 nm wavelength, “n=no” applies and the transmittance of the liquid crystal aperture control element 16a becomes 1. By setting “Veff” to 1.83 V, “n=ne−130/780×(ne−no)” applies and the transmittance of the liquid crystal aperture control element 16a becomes 0. By setting “Veff” to 3.5 V for the light of 780 nm wavelength, “n=no” applies and the transmittance of the liquid crystal aperture control element 16a becomes 1. By setting “Veff” to 1.5 V, “n=ne” applies and the transmittance of the liquid crystal aperture control element 16a becomes 0.

The structure of the liquid crystal aperture control element 16b is the same as the structure shown in FIG. 4.

When the disk 6 is a disk of the BD standard, the effective values of the AC voltages are set as “Veffa=3.5 V”, “Veffb=3.5 V”, “Veffc=3.5 V”, and “Veffd=3.5 V”. In this case, as shown in FIG. 3A, almost all the light out of the incident light of 405 nm wavelength passing through any of the regions 36a, 36b, 36c, and 36d is transmitted without being affected by the diffraction effect at the liquid crystal aperture control element 16b. Thereby, the numerical aperture of the objective lens 5 is determined according to the effective diameter of the objective lens 5, and it takes a value of 0.85 that is the condition of the BD standard. When the disk 6 is a disk of the HD DVD standard, the effective values of the AC voltages are set as “Veffa=3.5 V”, “Veffb=3.5 V”, “Veffc=3.5 V”, and “Veffd=2.46 V”. In this case, as shown in FIG. 3B, almost all the light out of the incident light of 405 nm wavelength passing through the regions 36a, 36b, and 36c is transmitted without being affected by the diffraction effect at the liquid crystal aperture control element 16b, while the light passing through the region 36d is almost completely diffracted by being affected by the diffraction effect at the liquid crystal aperture control element 16b. Thereby, the effective numerical aperture of the objective lens 5 is determined according to the diameter of the circle that is the boundary between the region 36c and the region 36d, and it takes a value of 0.65 that is the condition of the HD DVD standard. When the disk 6 is a disk of the DVD standard, the effective values of the AC voltages are set as “Veffa=3.5 V”, “Veffb=3.5 V”, “Veffc=1.83 V”, and “Veffd=1.83 V”. In this case, as shown in FIG. 3C, almost all the light out of the incident light of 650 nm wavelength passing through the regions 36a and 36b is transmitted without being affected by the diffraction effect at the liquid crystal aperture control element 16b, while the light passing through the regions 36c and 36d is almost completely diffracted by being affected by the diffraction effect at the liquid crystal aperture control element 16b. Thereby, the effective numerical aperture of the objective lens 5 is determined according to the diameter of the circle that is the boundary between the region 36b and the region 36c, and it takes a value of 0.6 that is the condition of the DVD standard. When the disk 6 is a disk of the CD standard, the effective values of the AC voltages are set as “Veffa=3.5 V”, “Veffb=1.5 V”, “Veffc=1.5 V”, and “Veffd=1.5 V”. In this case, as shown in FIG. 3D, almost all the light out of the incident light of 780 nm wavelength passing through the region 36a is transmitted without being affected by the diffraction effect at the liquid crystal aperture control element 16b, while the light passing through the regions 36b, 36c, and 36d is almost completely diffracted by being affected by the diffraction effect at the liquid crystal aperture control element 16b. Thereby, the effective numerical aperture of the objective lens 5 is determined according to the diameter of the circle that is the boundary between the region 36a and the region 36b, and it takes a value of 0.45 that is the condition of the CD standard. As described above, the use of the liquid crystal aperture control element 16b makes it possible to control the effective numerical aperture of the objective lens 5 in, accordance with the kind of the disk 6.

### Sixth Exemplary Embodiment

An optical head device according to a sixth exemplary embodiment is a device in which the liquid crystal refracting lens 11 as the variable focal-point lens which configures the lens system in the fifth exemplary embodiment is replaced with a liquid crystal refracting lens 12.

The actions of the liquid crystal refracting lens 12 of the sixth exemplary embodiment are the same as those described in the second exemplary embodiment.

### Seventh Exemplary Embodiment

FIG. 12 shows an optical head device according to a seventh exemplary embodiment. The optical head device according to the seventh exemplary embodiment is a device in which the liquid crystal refracting lens that is a variable focal-point lens which configures the lens system in the fifth exemplary embodiment is replaced with a liquid crystal diffraction lens 13b and a liquid crystal refracting lens 14a that is an auxiliary lens system.

The structure of the liquid crystal diffraction lens 13b is the same as the structure shown in FIG. 9.

The structure of the liquid crystal refracting lens 14b is the same as the structure shown in FIG. 7. When the effective value of the AC voltage to be applied to the electrodes sandwiching the liquid crystal polymer 22a is 3.5 V in the center part and 1.5 V-3.5 V in the peripheral part (when the effective value of the AC voltage changes from the center part towards the peripheral part), and the effective value of the AC voltage applied to the electrodes sandwiching the liquid crystal polymer 22b is 3.5 V in the center part and 1.5 V-3.5 V in the peripheral part (when the effective value of the AC voltage changes from the center part towards the peripheral part), the liquid crystal refracting lens 14b works for the outgoing light as a concave lens hat has a focal distance set according to the difference between the values (in the center part and the peripheral part) of the refractive index of the liquid crystal polymer 22a determined by the effective value of the AC voltage to be applied to the electrodes sandwiching the liquid crystal polymer 22a, and works for the incoming light as a concave lens that has a focal distance set according to the difference between the values (in the center part and the peripheral part) of the refractive index of the liquid crystal polymer 22b determined by the effective value of the AC voltage to be applied to the electrodes sandwiching the liquid crystal polymer 22b. In the meantime, when the effective value of the AC voltage to be applied to the electrodes sandwiching the liquid crystal polymer 22a is 1.5 V in the center part and 1.5 V-3.5 V in the peripheral part (when the effective value of the AC voltage changes from the center part towards the peripheral part), and the effective value of the AC voltage applied to the electrodes sandwiching the liquid crystal polymer 22b is 1.5 V in the center part and 1.5 V-3.5 V in the peripheral part (when the effective value of the AC voltage changes from the center part towards the peripheral part), the liquid crystal refracting lens 14b works for the outgoing light as a convex lens hat has a focal distance set according to the difference between the values (in the center part and the peripheral part) of the refractive index of the liquid crystal polymer 22a determined by the effective value of the AC voltage to be applied to the electrodes sandwiching the liquid crystal polymer 22a, and works for the incoming light as a convex lens that has a focal distance set according to the difference between the values (in the center part and the peripheral part) of the refractive index of the liquid crystal polymer 22b determined by the effective value of the AC voltage to be applied to the electrodes sandwiching the liquid crystal polymer 22b. By making the effective value of the AC voltage applied to the electrodes sandwiching the liquid crystal polymer 22a equivalent to the effective value of the AC voltage applied to the electrodes sandwiching the liquid crystal polymer 22b in the center part as well as in the peripheral part, the focal distance of the liquid crystal refracting lens 14b for the outgoing light becomes equivalent to the focal distance of the liquid crystal refracting lens 14b for the incoming light.

It is assumed here that the focal distance of the objective lens 5 is 2.35 mm, an object distance at which the spherical aberration is corrected for the thickness 0.1 mm of the protection layer that is the condition of the BD standard is ∞ (magnification is 0), an objective distance at which the spherical aberration is corrected for the thickness 0.6 mm of the protection layer that is the condition of the HD DVD standard and the condition of the DVD standard is 36 mm (magnification is −2.35/36), for example, and an objective distance at which the spherical aberration is corrected for the thickness 1.2 mm of the protection layer that is the condition of the CD standard is 23 mm (magnification is −2.35/23), for example. Further, is also assumed that the distance from the objective lens 5 to the liquid crystal diffraction lens 13b is 2 mm, for example. In this case, the focal distance of the liquid crystal diffraction lens 13b may be set as ∞ in order to correct the spherical aberration when the disk 6 is the disk of the BD standard, and the focal distance of the liquid crystal diffraction lens 13b may be set as −34 mm when the disk 6 is a disk of the HD DVD standard or the DVD standard. The focal distance of the liquid crystal diffraction lens 13b may be set as −21 mm when the disk 6 is the disk of the CD standard.

Provided that both the effective value of the AC voltage to be applied to the electrodes sandwiching the liquid crystal polymer 22a and the effective value of the AC voltage to be applied to the electrodes sandwiching the liquid crystal polymer 22b of the liquid crystal diffraction lens 13b are “Veff”, and both the refractive index of the liquid crystal polymer 24a for the outgoing light determined accordingly and the refractive index of the liquid crystal polymer 24b for the incoming light are “n”, “n=ne−(Veff−1.5)/2×(ne−no)” applies within a range of “1.5 V<Veff<3.5 V”. Further, it is also assumed that both the thickness of the diffraction lens formed on the surface of the filler 25a on the liquid crystal polymer 24a side and the thickness of the diffraction lens formed on the surface of the filler 25b on the liquid crystal polymer 24b side are “λ/(ne−no)” (where λ=780 nm). In this case, both the phase depth of the diffraction lens formed on the surface of the filler 25a on the liquid crystal polymer 24a side and the depth of the diffraction lens formed on the surface of the filler 25b on the liquid crystal polymer 24b side are “780/405×2π(n−no)/(ne−no)” for the light of 405 nm wavelength, “780/650×2π(n−no)/(ne−no)” for the light of 650 nm wavelength, and “2π(n−no)/(ne−no)” for the light of 780 nm wavelength. The phase depth for the light of 405 nm wavelength becomes 0 when “n=no” applies, and both the transmittance (efficiency of zeroth-order light) of the liquid crystal diffraction lens 13b for the outgoing light and the transmittance (efficiency of zeroth-order light) of the liquid crystal diffraction lens 13b for the incoming light become 1. The phase depth becomes 2π when “n=ne−375/780×(ne−no)” applies, and both the first-order diffraction efficiency for the outgoing light and the first-order diffraction efficiency for the incoming light become 1. The phase depth for the light of 650 nm wavelength becomes 0 when “n=no” applies, and both the transmittance (efficiency of zeroth-order light) of the liquid crystal diffraction lens 13b for the outgoing light and the transmittance (efficiency of zeroth-order light) of the liquid crystal diffraction lens 13b for the incoming light become 1. The phase depth becomes 2π when “n=ne−130/780×(ne−no)” applies, and both the first-order diffraction efficiency for the outgoing light and the first-order diffraction efficiency for the incoming light become 1. The phase depth for the light of 780 nm wavelength becomes 0 when “n=no” applies, and both the transmittance (efficiency of zeroth-order light) of the liquid crystal diffraction lens 13b for the outgoing light and the transmittance (efficiency of zeroth-order light) of the liquid crystal diffraction lens 13b for the incoming light become 1. The phase depth becomes 2π when “n=ne” applies, and both the first-order diffraction efficiency for the outgoing light and the first-order diffraction efficiency for the incoming light become 1.

Furthermore, it is assumed that the distance from the optical axis is “r (mm)” and both the grating pitch of the diffraction lens formed on the filler 25a on the liquid crystal polymer 24a side and the grating pitch of the diffraction lens formed on the filler 25b on the liquid crystal polymer 24b side are “p (nm)”. In this case, for the light of 405 nm wavelength, when “p” is changed with respect to “r” to satisfy “p=−f·λ/r (where λ=780 nm)”, the focal distance of the liquid crystal diffraction lens and the focal distance of the liquid crystal diffraction lens 13b for the incoming transmission light (zeroth-order light) both become ∞. Thus, the focal distance for the outgoing first-order diffraction light and the focal distance for the incoming first-order diffraction light both become “780/405×f”. For the light of 650 nm wavelength, the focal distance of the liquid crystal diffraction lens 13b for the outgoing transmission light (zeroth-order light) and the focal distance of the liquid crystal diffraction lens 13b for the incoming transmission light (zeroth-order light) both become ∞. Thus, the focal distance for the outgoing first-order diffraction light and the focal distance for the incoming first-order diffraction light both become “780/650×f”. For the light of 780 nm wavelength, the focal distance of the liquid crystal diffraction lens 13b for the outgoing transmission light (zeroth-order light) and the focal distance of the liquid crystal diffraction lens 13b for the incoming transmission light (zeroth-order light) both become ∞. Thus, the focal distance for the outgoing first-order diffraction light and the focal distance for the incoming first-order diffraction light both become “f”. It is assumed here that “f=−22.6 mm”. Thus, when “Veff” is set to 3.5 V for the light of 405 nm wavelength, “n=no” applies, and the incident light for the liquid crystal diffraction lens 13b becomes transmission light (zeroth-order light). Therefore, the focal distance of the liquid crystal diffraction lens 13b becomes ∞. Further, “n=ne−375/780×(ne−no)” applies when “Veff” is set to 2.46 V, and the incident light for the liquid crystal diffraction lens 13b becomes the first-order diffraction light. Therefore, the focal distance of the liquid crystal diffraction lens 13b becomes −43.5 mm. When “Veff” is set to 3.5 V for the light of 650 nm wavelength, “n=no” applies, and the incident light for the liquid crystal diffraction lens 13b becomes transmission light (zeroth-order light). Therefore, the focal distance of the liquid crystal diffraction lens 13b becomes ∞. Further, “n=ne−130/780×(ne−no)” applies when “Veff” is set to 1.83 V, and the incident light for the liquid crystal diffraction lens 13b becomes the first-order diffraction light. Therefore, the focal distance of the liquid crystal diffraction lens 13b becomes −27.1 mm. When “Veff” is set to 3.5 V for the light of 780 nm wavelength, “n=no” applies, and the incident light for the liquid crystal diffraction lens 13b becomes transmission light (zeroth-order light). Therefore, the focal distance of the liquid crystal diffraction lens 13b becomes ∞. Further, “n=ne” applies when “Veff” is set to 1.5 V, and the incident light for the liquid crystal diffraction lens 13b becomes the first-order diffraction light. Therefore, the focal distance of the liquid crystal diffraction lens 13b becomes −22.6 mm.

When the disk 6 is a disk of the BD standard, “Veff” is set to 3.5 V. In this case, the incident light of 405 nm wavelength is transmitted as transmission light (zeroth-order light) without being affected by the diffraction effect at the liquid crystal diffraction lens 13b. Thereby, the magnification of the objective lens 5 becomes 0. In order to correct the spherical aberration for the thickness 0.1 mm of the protection layer that is the condition of the BD standard, the position of the objective point or the liquid crystal diffraction lens 13b may be set as ∞ since the position of the image point for the liquid crystal diffraction lens 13b is ∞. When the disk 6 is a disk of the HD DVD standard, “Veff” is set to 2.46 V. In this case, the incident light of 405 nm wavelength is diffracted as the first-order diffraction light by being affected by the diffraction effect at the liquid crystal diffraction lens 13b. Thereby, the magnification of the objective lens 5 becomes −2.35/36. In order to correct the spherical aberration for the thickness 0.6 mm of the protection layer that is the condition of the HD DVD standard, the position of the objective point for the liquid crystal diffraction lens 13b may be set as 155.4 mm when the thickness of the liquid crystal diffraction lens 13b is ignored for simplification, since the position of the image point for the liquid crystal diffraction lens 13b is −34 mm and the focal distance of the liquid crystal diffraction lens 13a is −43.5 mm. When the disk 6 is a disk of the DVD standard, “Veff” is set to 1.83 V. In this case, the incident light of 650 nm wavelength is diffracted as the first-order diffraction light by being affected by the diffraction effect at the liquid crystal diffraction lens 13b. Thereby, the magnification of the objective lens 5 becomes −2.35/36. In order to correct the spherical aberration for the thickness 0.6 mm of the protection layer that is the condition of the DVD standard, the position of the objective point for the liquid crystal diffraction lens 13b may be set as −134 mm when the thickness of the liquid crystal diffraction lens 13b is ignored for simplification, since the position of the image point for the liquid crystal diffraction lens 13b is −34 mm and the focal distance of the liquid crystal diffraction lens 13b is −27.1 mm. When the disk 6 is a disk of the CD standard, “Veff” is set to 1.5 V. In this case, the incident light of 780 nm wavelength is diffracted as the first-order diffraction light by being affected by the diffraction effect at the liquid crystal diffraction lens 13b. Thereby, the magnification of the objective lens 5 becomes −2.35/23. In order to correct the spherical aberration for the thickness 1.2 mm of the protection layer that is the condition of the CD standard, the position of the objective point for the liquid crystal diffraction lens 13b may be set as 296.6 mm when the thickness of the liquid crystal diffraction lens 13b is ignored for simplification, since the position of the image point for the liquid crystal diffraction lens 13b is −21 mm and the focal distance of the liquid crystal diffraction lens 13b is −22.6 mm. Furthermore, it is so defined that the distance from the liquid crystal diffraction lens 13b to the liquid crystal refracting lens 14b is 10 mm, for example. In this case, in order to correct the spherical aberration, the focal distance of the liquid crystal refracting lens 14b may be set as ∞ when the disk 6 is of BD standard, the focal distance of the liquid crystal refracting lens 14b may be set as −145.4 mm when the disk 6 is of the HD DVD standard, the focal distance of the liquid crystal refracting lens 14b may be set as 144 mm when the disk 6 is of the DVD standard, and the focal distance of the liquid crystal refracting lens 14b may be set as −286.6 mm when the disk 6 is of the CD standard.

Provided that both the effective value of the AC voltage to be applied to the electrodes sandwiching the liquid crystal polymer 22a and the effective value of the AC voltage to be applied to the electrodes sandwiching the liquid crystal polymer 22b of the liquid crystal refracting lens 14b are “Veff”, and both the refractive index of the liquid crystal polymer 22a for the outgoing light determined accordingly and the refractive index of the liquid crystal polymer 22b for the incoming light are “n”, “n=ne−(Veff−1.5)/2×(ne−no)” applies within a range of “1.5 V<Veff<3.5 V”. Further, it is also assumed that the distance from the optical axis is “r (mm)” and both the thickness of the liquid crystal polymer 22a and the thickness of the liquid crystal polymer 22b are “t (mm)”. In this case, when “n” is changed in a quadratic function manner with respect to “r” so as to satisfy “no−n=r²/(2·f·t)” or “ne−n=r²/(2·f·t)”, the focal distance of the liquid crystal refracting lens 14b for the outgoing light and the focal distance of the liquid crystal refracting lens 14b for the incoming light both become “f (mm)”. When the left side is “no−n”, “f” takes a negative value. Thus, the liquid crystal refracting lens 14b becomes a concave lens. When the left side is “ne−n”, “f” takes a positive value. Thus, the liquid crystal refracting lens 14b becomes a convex lens. When “r” corresponding to the effective diameter of the objective lens 5 is defined as “r0” and “t” is defined as “t=r0²/288(ne−no) (mm)”, the above expression becomes “n=no−144/f×(ne−no)×(r/r0)²” or “n=ne−144/f×(ne−no)×(r/r0)²”. Therefore, in order to set the focal distance of the liquid crystal refracting lens 14b to be ∞, “n=no” or “n−ne” may be satisfied both in the center part (r=0 mm) and in the peripheral part (r=r0). For that, “Veff” may be set to 3.5 V in both the center part and the peripheral part or “Veff” may be set to 1.5 V in both the center part and the peripheral part. In order to set the focal distance of the liquid crystal refracting lens 14b to be −145.4 mm, “n=no” may be satisfied in the center part and “n=ne−1.4/145.4×(ne−no)” may be satisfied in the peripheral part. For that, “Veff” may be set to 3.5 V in the center part and may be set to 1.52 V in the peripheral part. In order to set the focal distance of the liquid crystal refracting lens 14b to be 199 mm, “n=ne” may be satisfied in the center part and “n=no” may be satisfied in the peripheral part. For that, “Veff” may be set to 1.5 V in the center part and may be set to 3.5 V in the peripheral part. In order to set the focal distance of the liquid crystal refracting lens 14b to be −286.6 mm, “n=no” may be satisfied in the center part and “n=ne−142.6/286.6×(ne−no)” may be satisfied in the peripheral part. For that, “Veff” may be set to 3.5 V in the center part and may be set to 2.5 V in the peripheral part.

When the disk 6 is a disk of the BD standard, “Veff” is set to 3.5 V in the center part as well as in the peripheral part or set to 1.5 V in the center part as well as in the peripheral part. In this case, the incident light of 405 nm wavelength is transmitted without being affected by the diffraction effect at the liquid crystal refracting lens 14b. Thereby, the position of the object point for the liquid crystal diffraction lens 13b becomes ∞, and the spherical aberration is corrected for the thickness 0.1 mm of the protection layer that is the condition of the BD standard. When the disk 6 is a disk of the HD DVD standard, “Veff” is set to 3.5 V in the center part and set to 1.52 V in the peripheral part. In this case, the incident light of 405 nm wavelength is transmitted by being affected by the refraction effect at the liquid crystal refracting lens 14 as a concave lens having the focal distance of −145.4 mm. Thereby, the position of the object point for the liquid crystal diffraction lens 13b becomes 155.4 mm, and the spherical aberration is corrected for the thickness 0.6 mm of the protection layer that is the condition of the HD DVD standard. When the disk 6 is a disk of the DVD standard, “Veff” is set to 1.5 V in the center part and set to 3.5 V in the peripheral part. In this case, the incident light of 650 nm wavelength is transmitted by being affected by the refraction effect at the liquid crystal refracting lens 14b as a convex lens having the focal distance of 144 mm. Thereby, the position of the object point for the liquid crystal diffraction lens 13b becomes −134 mm, and the spherical aberration is corrected for the thickness 0.6 mm of the protection layer that is the condition of the DVD standard. When the disk 6 is a disk of the CD standard, “Veff” is set to 3.5 V in the center part and set to 1.5 V in the peripheral part. In this case, the incident light of 780 nm wavelength is transmitted by being affected by the refraction effect at the liquid crystal refracting lens 14b as a concave lens having the focal distance of −286.6 mm. Thereby; the position of the object point for the liquid crystal diffraction lens 13b becomes 296.6 mm, and the spherical aberration is corrected for the thickness 1.2 mm of the protection layer that is the condition of the CD standard. As described, the use of the liquid crystal refracting lens 14b makes it possible to change the focal distance continuously within a range of ∞ to ±144 mm, so that the spherical aberrations in the outgoing light and the incoming light, which vary depending on the kind of the disk 6, can be corrected. As a result, it becomes possible to perform recording and reproduction to/from the disks of the BD standard, the HD DVD standard, the DVD standard, and the CD standard in a fine manner.

It is also possible to employ a form in which the liquid crystal refracting lens 14b of the optical head device according to the seventh exemplary embodiment is replaced with an expander lens that is configured with a concave lens and a convex lens. When the disk 6 is a disk of the BD standard, the space between the concave lens and the convex lens is controlled so that light making incident on the concave lens as parallel light exits from the convex lens as the parallel light, and the position of the object point for the liquid crystal diffraction lens 13b becomes ∞. When the disk 6 is a disk of the HD DVD standard, the space between the concave lens and the convex lens is controlled so that light making incident on the concave lens as parallel light exits from the convex lens as divergent light of proper divergent angles, and the position of the object point for the liquid crystal diffraction lens 13b becomes 155.4 mm. When the disk 6 is a disk of the DVD standard, the space between the concave lens and the convex lens is controlled so that light making incident on the concave lens as parallel light exits from the convex lens as convergent light of proper convergent angles, and the position of the object point for the liquid crystal diffraction lens 13b becomes −134 mm. When the disk 6 is a disk of the CD standard, the space between the concave lens and the convex lens is controlled so that light making incident on the concave lens as parallel light exits from the convex lens as divergent light with proper divergent angles, and the position of the object point for the liquid crystal diffraction lens 13b becomes 296.6 mm.

### Eighth Exemplary Embodiment

An optical head device according to an eighth exemplary embodiment is a device in which the liquid crystal refracting lens 11 as the variable focal-point lens which configures the lens system in the fifth exemplary embodiment is replaced with a liquid lens 15.

The actions of the liquid lens 15 of the eighth exemplary embodiment are the same as those described in the fourth exemplary embodiment.

### Ninth Exemplary Embodiment

A case where the optical head according to the first exemplary embodiment is applied to an optical information recording/reproducing device will be described as a ninth exemplary embodiment.

As shown in FIG. 13, the optical information recording/reproducing device according to the ninth exemplary embodiment is the optical head device of the first exemplary embodiment to which a modulation circuit 38, a recording signal generating circuit 39, a semiconductor laser driving circuit 40, an amplifying circuit 41, a reproducing signal processing circuit 42, a demodulation circuit 43, an error signal generating circuit 44, an objective lens driving circuit 45, a disk judging circuit 46, a liquid crystal lens driving circuit 47, and a liquid crystal aperture control element driving circuit 49a are added.

The modulation circuit 38 modulates data to be recorded to the disk 6 according to a modulation rule. The recording signal generating circuit 39 generates a recording signal for driving the semiconductor laser 1a according to a recording strategy based on the signals modulated by the modulation circuit 38. The semiconductor laser driving circuit 40 drives the semiconductor laser 1a by supplying, to the semiconductor laser 1a, an electric current according to the recording signal generated by the recording signal generating circuit 39. With this, data is recorded to the disk 6.

The amplifying circuit 41 amplifies outputs form each receiving part of a photodetector 9. The reproducing signal processing circuit 42 performs generation, waveform equalization, and binarization of an RF signal that is a mark/space signal recorded on the disk 6. The demodulation circuit 43 demodulates the signal binarized in the reproducing signal processing circuit 42 according to a demodulation rule. With this, data is reproduced from the disk 6.

The error signal generating circuit 44 generates a focus error signal and a track error signal based on the signal amplified by the amplifying circuit 41. The objective lens driving circuit 45 drives the objective lens 5 by supplying an electric current according to the focus error signal and the track error signal to an actuator (not shown) which drives the objective lens 5 based on the focus error signal and the track error signal generated by the error signal generating circuit 44. Further, the optical system except for the disk 6 is driven in the radial direction of the disk 6 by a positioner (not shown), and the disk 6 is rotated by a spindle (not shown). With this, servo-controls of the focus, track, positioner, and spindle can be conducted.

The disk judging circuit 46 judges the standard of the disk 6 based on the signal amplified by the amplifying circuit 46. The disk judging circuit 46 checks the thickness (0.1 mm, 0.6 mm, or 1.2 mm) of the protection layer based on the interval of the zero-cross points of the focus error signals from the surface and the recording face of the disk 6. If the thickness of the protection layer is 0.1 mm, the disk judging circuit 46 judges that the disk 6 is of the BD standard. If the thickness of the protection layer is 0.6 mm, the disk judging circuit 46 judges that the disk 6 is of the HD DVD standard. If the thickness of the protection layer is 1.2 mm, the disk judging circuit 46 judges that the disk 6 is of the CD standard. When the disk 6 is of the HD DVD standard or DVD standard, the disk judging circuit 46 checks whether or not a system lead-in signal is recorded in the innermost periphery. If the system lead-in signal is recorded, the disk judging circuit 46 judges that it is the disk of the HD DVD standard. If the system lead-in signal is not recorded, the disk judging circuit 46 judges that it is the disk of the DVD standard. The liquid crystal lens driving circuit 47 drives the liquid crystal refracting lens 11 by applying a voltage to the electrodes of the liquid crystal refracting lens 11 in accordance with the kind of the disk 6 judged by the disk judging circuit 46. Further, the liquid crystal aperture control element driving circuit 49a drives the liquid crystal aperture control element 16a by applying a voltage to the electrodes of the liquid crystal aperture control element 16a in accordance with the kind of the disk 6 judged by the disk judging circuit 46. Thereby, correction of the spherical aberration and control of the effective numerical aperture of the objective lens 5 can be conducted in accordance with the kind of the disk 6.

The circuits from the modulation circuit 38 to the semiconductor laser driving circuit 40 related to recording of data, the circuits from the amplifying circuit 41 to the demodulation circuit 43 related to reproduction of data, the circuits from the amplifying circuit 41 to the objective lens driving circuit 45 related to servo, and the circuits from the amplifying circuit 41 to the liquid crystal aperture control element driving circuit 49a related to transposition are controller by a controller (not shown).

The optical information recording/reproducing device according to the ninth exemplary embodiment is an optical information recording/reproducing device which performs recording and reproduction of information to/from the disk 6. However, the device is not limited only to such case. The optical information recording/reproducing device according to the exemplary embodiment includes an optical information reproduction-only device which performs reproduction only from the disk 6. In this case, the semiconductor lens 1a is driven not based on the recording signal. The semiconductor lane 1a in this case is driven in such a manner that the power of the emission light becomes constant.

### Tenth Exemplary Embodiment

A case where the optical head device according to the second exemplary embodiment is applied to an optical information recording/reproducing device will be described as a tenth exemplary embodiment. The optical information recording/reproducing device according to the tenth exemplary embodiment is the optical head device of the second exemplary embodiment to which a modulation circuit 38, a recording signal generating circuit 39, a semiconductor laser driving circuit 40, an amplifying circuit 41, a reproducing signal processing circuit 42, a demodulation circuit 43, an error signal generating circuit 44, an objective lens driving circuit 45, a disk judging circuit 46, a liquid crystal lens driving circuit 47, and a liquid crystal aperture control element driving circuit 49a are added. The liquid crystal lens driving circuit 47 drives the liquid crystal refracting lens 12 by applying a voltage to the electrodes of the liquid crystal refracting lens 12 in accordance with the kind of the disk 6 judged by the disk judging circuit 46.

### Eleventh Exemplary Embodiment

A case where the optical head device according to the third exemplary embodiment is applied to an optical information recording/reproducing device will be described as an eleventh exemplary embodiment. The optical information recording/reproducing device according to the eleventh exemplary embodiment shown in FIG. 14 is the optical head device of the third exemplary embodiment to which a modulation circuit 38, a recording signal generating circuit 39, a semiconductor laser driving circuit 40, an amplifying circuit 41, a reproducing signal processing circuit, 42, a demodulation circuit 43, an error signal generating circuit 44, an objective lens driving circuit 45, a disk judging circuit 46, a liquid crystal lens driving circuit 48a, and a liquid crystal aperture control element driving circuit 49a are added. The liquid crystal lens driving circuit 48a drives the liquid crystal diffraction lens 13a and the liquid crystal refracting lens 14a by applying a voltage to the electrodes of liquid crystal diffraction lens 13a and the liquid crystal refracting lens 14a in accordance with the kind of the disk 6 judged by the disk judging circuit 46.

As the optical information recording/reproducing device, it is also possible to employ a form in which the liquid crystal diffractive lens 14a of the third exemplary embodiment is replaced with an expander lens, the liquid crystal lens driving circuit 48a is used for the circuit for driving only the liquid crystal diffraction lens 13a, and an expander lens driving circuit for driving the expander lens is added. The liquid crystal lens driving circuit 48a drives the liquid crystal diffraction lens 13a by applying a voltage to the electrodes of the liquid crystal diffraction lens 13a in accordance with the kind of the disk 6 judged by the disk judging circuit 46. The expander lens driving circuit drives the expander lens by a motor or a piezoelectric element (not shown) in accordance with the kind of the disk 6 judged by the disk judging circuit 46.

### Twelfth Exemplary Embodiment

A case where the optical head device according to the fourth exemplary embodiment is applied to an optical information recording/reproducing device will be described as a twelfth exemplary embodiment. The optical information recording/reproducing device according to the twelfth exemplary embodiment is the optical head device of the fourth exemplary embodiment to which a modulation circuit 38, a recording signal generating circuit 39, a semiconductor laser driving circuit 40, an amplifying circuit 41, a reproducing signal processing circuit 42, a demodulation circuit 43, an error signal generating circuit 44, an objective lens driving circuit 45, a disk judging circuit 46, a liquid crystal lens driving circuit 47, and a liquid crystal aperture control element driving circuit 49a are added. The liquid crystal lens driving circuit 47 drives the liquid lens 15 by applying a voltage to the electrodes of the liquid lens 15 in accordance with the kind of the disk 6 judged by the disk judging circuit 46.

### Thirteenth Exemplary Embodiment

A case where the optical head device according to the fifth exemplary embodiment is applied to an optical information recording/reproducing device will be described as a thirteenth exemplary embodiment. The optical information recording/reproducing device according to the thirteenth exemplary embodiment shown in FIG. 15 is the optical head device of the fifth exemplary embodiment to which a modulation circuit 38, a recording signal generating circuit 39, a semiconductor laser driving circuit 40, an amplifying circuit 41, a reproducing signal processing circuit 42, a demodulation circuit 43, an error signal generating circuit 44, an objective lens driving circuit 45, a disk judging circuit 46, a liquid crystal lens driving circuit 47, and a liquid crystal aperture control element driving circuit 49b are added. The semiconductor laser driving circuit 40 drives the one of the semiconductor lasers 1a, 1b, and 1c by supplying, to the semiconductor laser 1a, 1b, or 1c, an electric current according to the recording signal generated by the recording signal generating circuit 39. The liquid crystal aperture control element driving circuit 49b drives the liquid crystal aperture control element 16b by applying a voltage to the electrodes of the liquid crystal aperture control element 16b in accordance with the kind of the disk 6 judged by the disk judging circuit 46.

### Fourteenth Exemplary Embodiment

A case where the optical head device according to the sixth exemplary embodiment is applied to an optical information recording/reproducing device will be described as a fourteenth exemplary embodiment. The optical information recording/reproducing device according to the fourteenth exemplary embodiment is the optical head device of the sixth exemplary embodiment to which a modulation circuit 38, a recording signal generating circuit 39, a semiconductor laser driving circuit 40, an amplifying circuit 41, a reproducing signal processing circuit 42, a demodulation circuit 43, an error signal generating circuit 44, an objective lens driving circuit 45, a disk judging circuit 46, a liquid crystal lens driving circuit 47, and a liquid crystal aperture control element driving circuit 49a are added. The liquid crystal lens driving circuit 47 drives the liquid crystal refracting lens 12 by applying a voltage to the electrodes of the liquid crystal refracting lens 12 in accordance with the kind of the disk 6 judged by the disk judging circuit 46.

### Fifteenth Exemplary Embodiment

A case where the optical head device according to the seventh exemplary embodiment is applied to an optical information recording/reproducing device will be described as a fifteenth exemplary embodiment. The optical information recording/reproducing device according to the fifteenth exemplary embodiment shown in FIG. 16 is the optical head device of the seventh exemplary embodiment to which a modulation circuit 38, a recording signal generating circuit 39, a semiconductor laser driving circuit 40, an amplifying circuit 41, a reproducing signal processing circuit 42, a demodulation circuit 43, an error signal generating circuit 44, an objective lens driving circuit 45, a disk judging circuit 46, a liquid crystal lens driving circuit 48b, and a liquid crystal aperture control element driving circuit 49b are added. The liquid crystal lens driving circuit 48b drives the liquid crystal diffraction lens 13b and the liquid crystal refracting lens 14b by applying a voltage to the electrodes of liquid crystal diffraction lens 13b and the liquid crystal refracting lens 14b in accordance with the kind of the disk 6 judged by the disk judging circuit 46.

As the optical information recording/reproducing device, it is also possible to employ a form in which the liquid crystal diffractive lens 14b of the fifteenth exemplary embodiment is replaced with an expander lens, the liquid crystal lens driving circuit 48b is used for the circuit for driving only the liquid crystal diffraction lens 13b, and an expander lens driving circuit for driving the expander lens is added. The liquid crystal lens driving circuit 48b drives the liquid crystal diffraction lens 13b by applying a voltage to the electrodes of the liquid crystal diffraction lens 13b in accordance with the kind of the disk 6 judged by the disk judging circuit 46. The expander lens driving circuit drives the expander lens by a motor or a piezoelectric element (not shown) in accordance with the kind of the disk 6 judged by the disk judging circuit 46.

### Sixteenth Exemplary Embodiment

A case where the optical head device according to the eighth exemplary embodiment is applied to an optical information recording/reproducing device will be described as a sixteenth exemplary embodiment. The optical information recording/reproducing device according to the sixteenth exemplary embodiment is the optical head device of the eighth exemplary embodiment to which a modulation circuit 38, a recording signal generating circuit 39, a semiconductor laser driving circuit 40, an amplifying circuit 41, a reproducing signal processing circuit 42, a demodulation circuit 43, an error signal generating circuit 44, an objective lens driving circuit 45, a disk judging circuit 46, a liquid crystal lens driving circuit 47, and a liquid crystal aperture control element driving circuit 49a are added. The liquid crystal lens driving circuit 47 drives the liquid lens 15 by applying a voltage to the electrodes of the liquid lens 15 in accordance with the kind of the disk 6 judged by the disk judging circuit 46.

While the present invention has been described by referring to the embodiments (and examples), the present invention is not limited only to those embodiments (and examples) described above. Various kinds of modifications that occur to those skilled in the art can be applied to the structures and details of the present invention within the scope of the present invention.

This application claims the Priority right based on JP 2006-284394 filed on Oct. 10, 2006, and the disclosure thereof is hereby incorporated by reference in its entirety.

### INDUSTRIAL APPLICABILITY

With the present invention, it is possible to perform recording and reproduction of information to/from three or more kinds of optical recording media of different standards.

### BRIEF DESCRIPTION OF THE DRAWINGS

FIG. 1 is an illustration showing an optical head device according to a first exemplary embodiment of the invention;

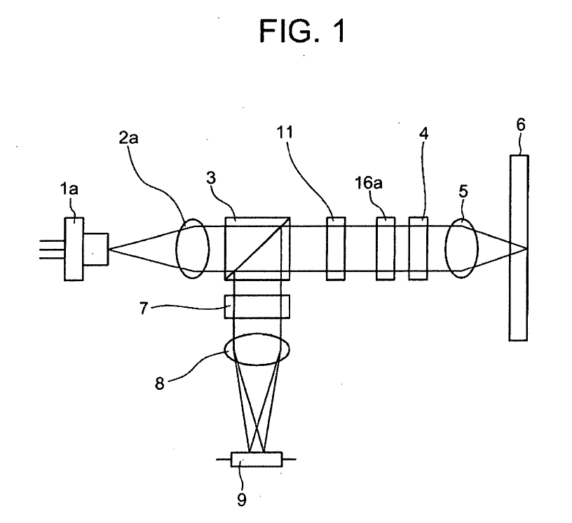

FIGS. 2A-2C are sectional views showing a liquid crystal refracting lens of the optical head device according to the first exemplary embodiment of the invention;

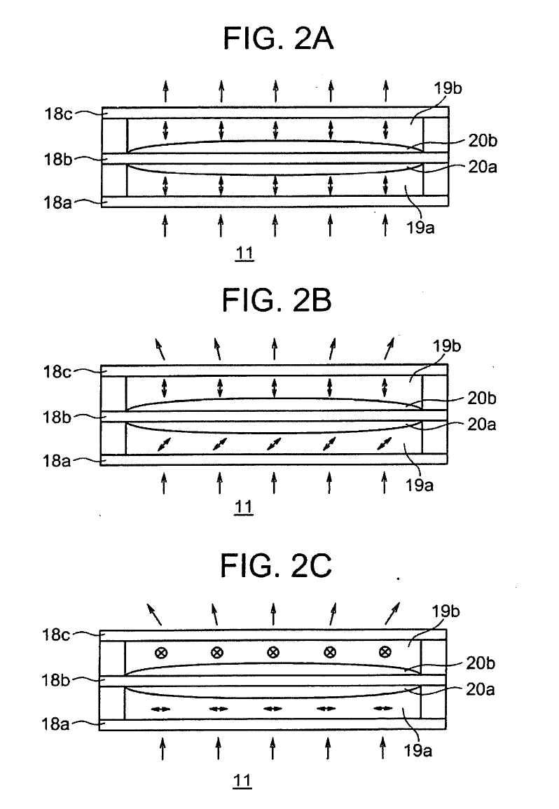

FIGS. 3A-3D are sectional views showing a liquid crystal aperture control element of the optical head device according to the first exemplary embodiment of the invention;

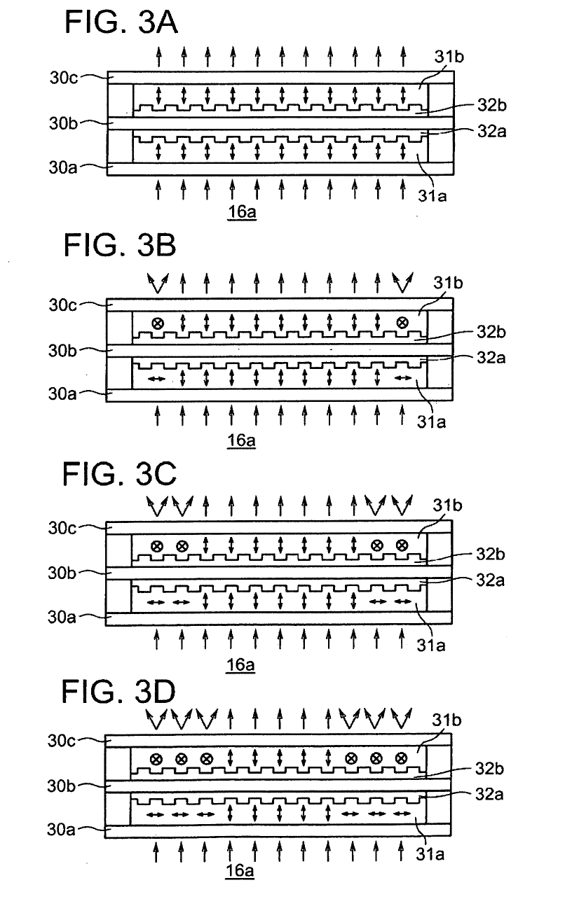

FIG. 4 is a plan view showing the liquid crystal aperture control element of the optical head device according to the first exemplary embodiment of the invention;

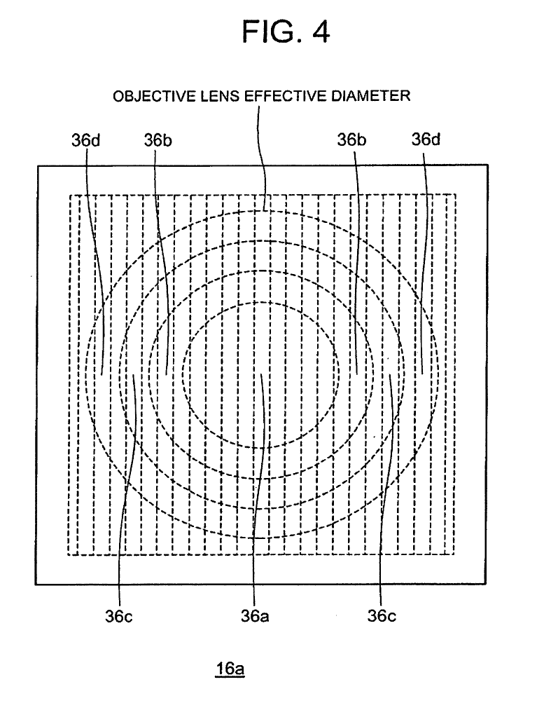

FIGS. 5A-5D are sectional views showing a liquid crystal aperture control element in a modification example of the optical head device according to the first exemplary embodiment of the invention;

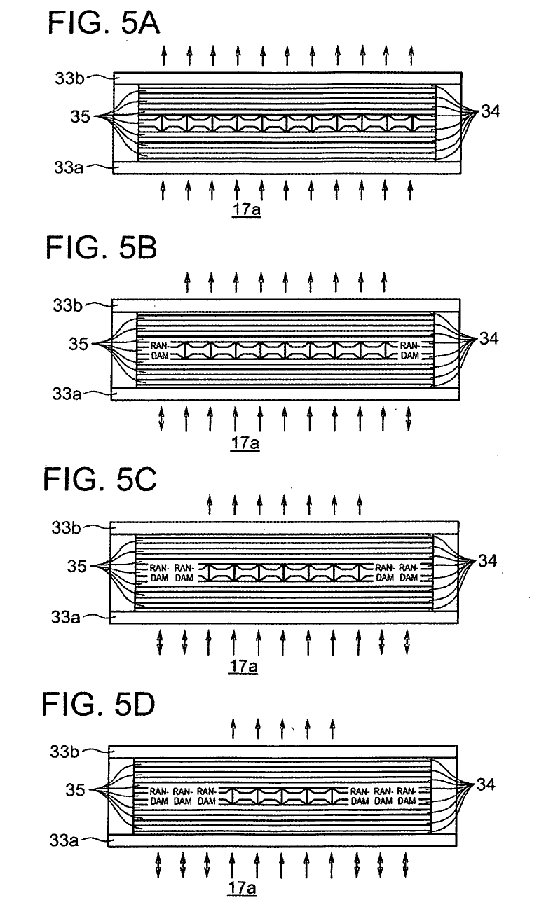

FIG. 6 is a plan view showing the liquid crystal aperture control element in the modification example of the optical head device according to the first exemplary embodiment of the invention;

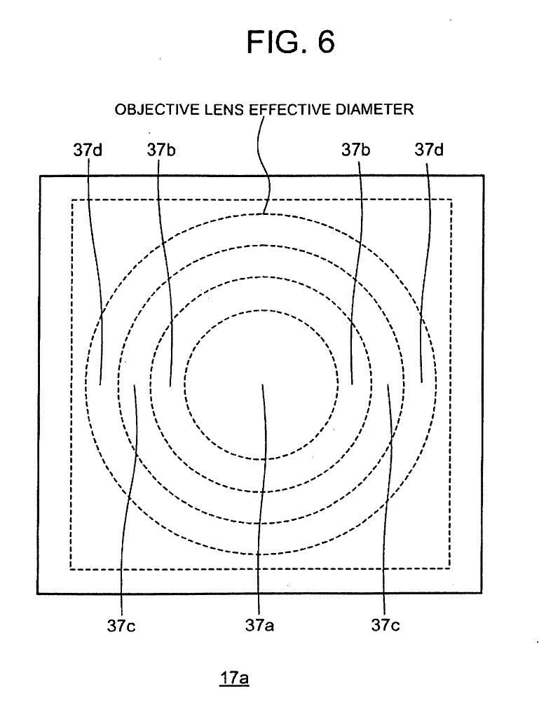

FIGS. 7A-7C are sectional views showing a liquid crystal refracting lens of an optical head device according to a second exemplary embodiment of the invention;

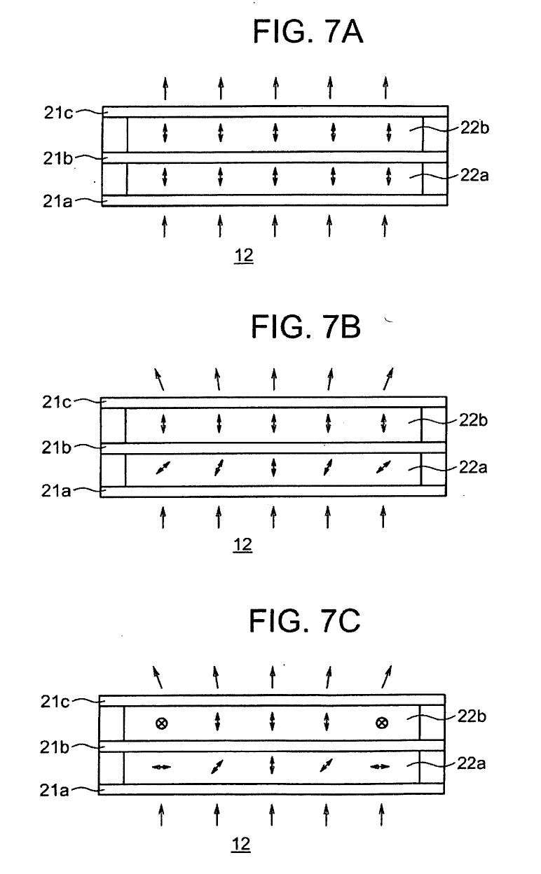

FIG. 8 is an illustration showing an optical head device according to a third exemplary embodiment of the invention;

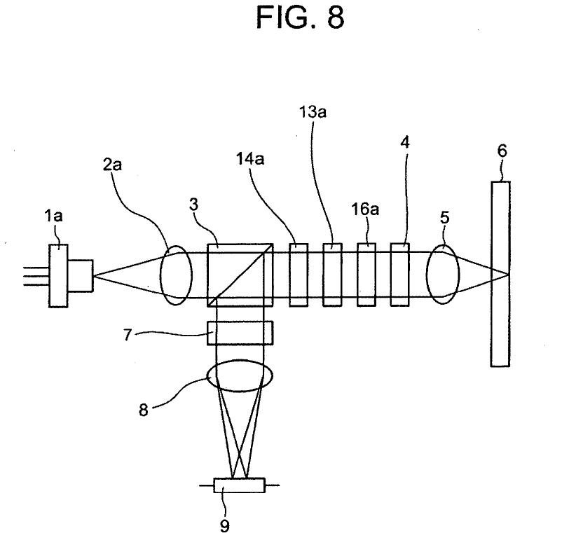

FIGS. 9A-9C are sectional views showing a liquid crystal refracting lens of the optical head device according to the third exemplary embodiment of the invention;

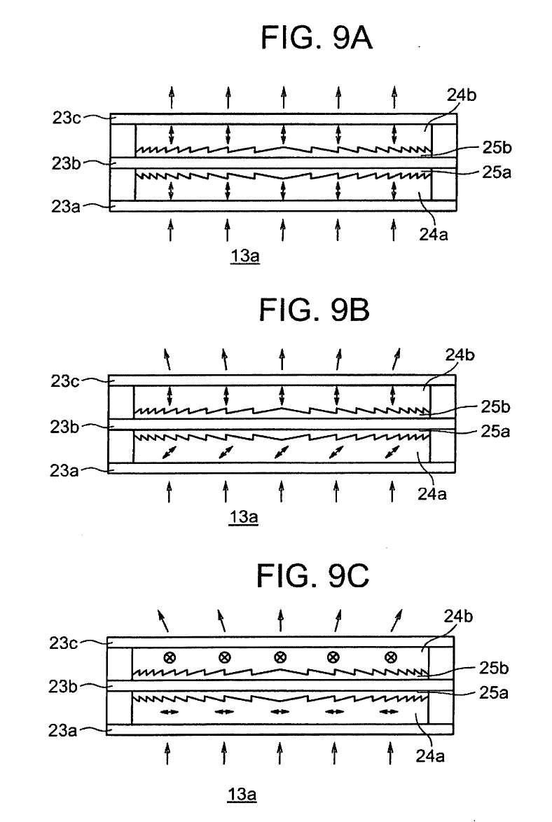

FIGS. 10A-100 are sectional views showing a liquid crystal refracting lens of an optical head device according to a fourth exemplary embodiment of the invention;

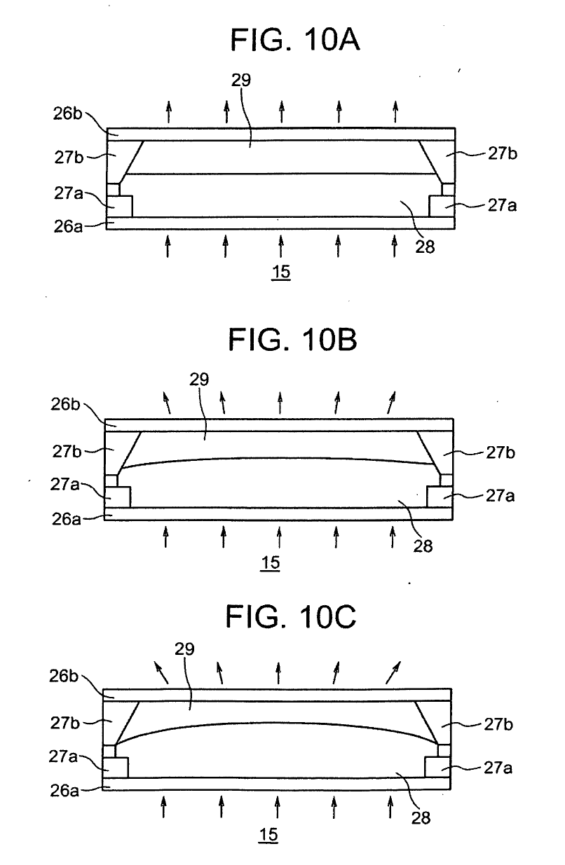

FIG. 11 is an illustration showing an optical head device according to a fifth exemplary embodiment of the invention;

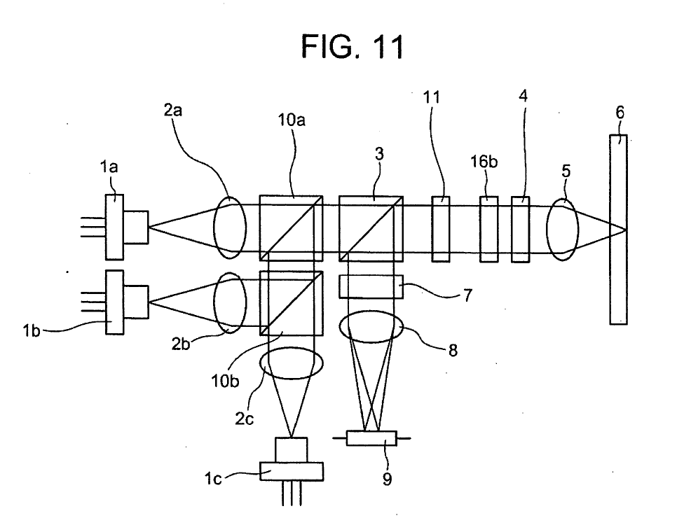

FIG. 12 is an illustration showing an optical head device according to a seventh exemplary embodiment of the invention;

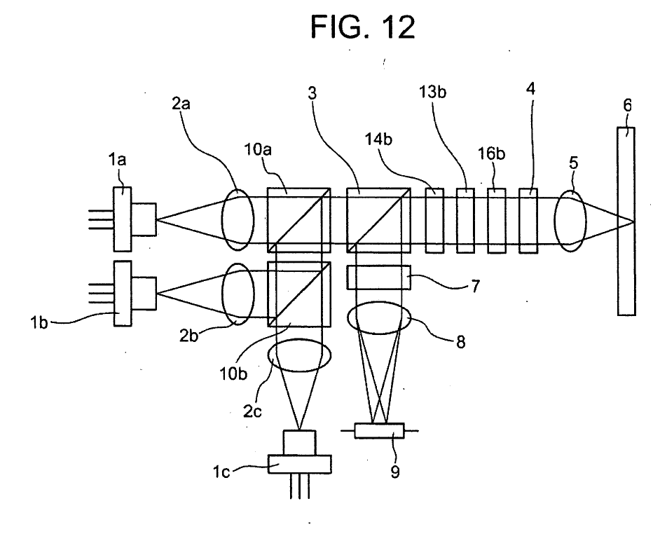

FIG. 13 is an illustration showing an optical information recording/reproducing device to which the optical head device according to the first exemplary embodiment of the invention is applied;

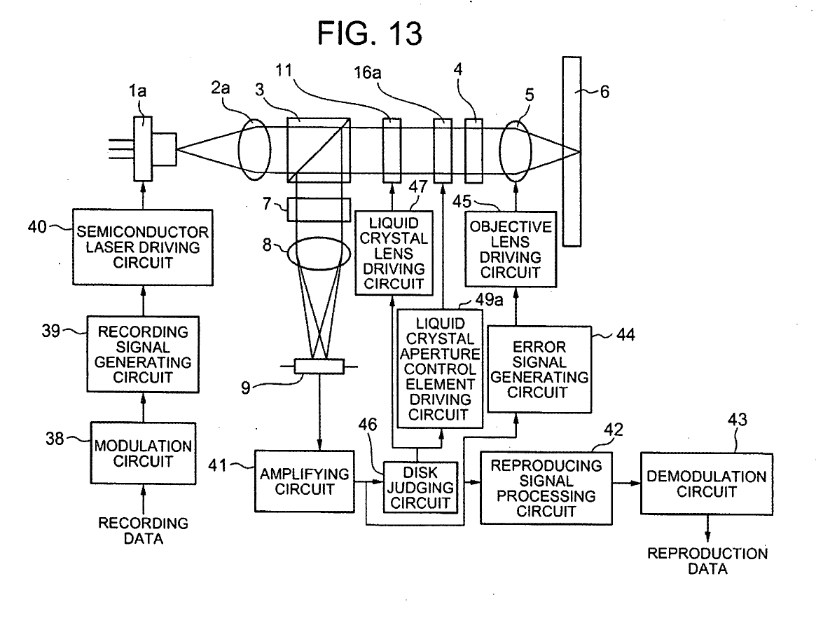

FIG. 14 is an illustration showing an optical information recording/reproducing device to which the optical head device according to the third exemplary embodiment of the invention is applied;

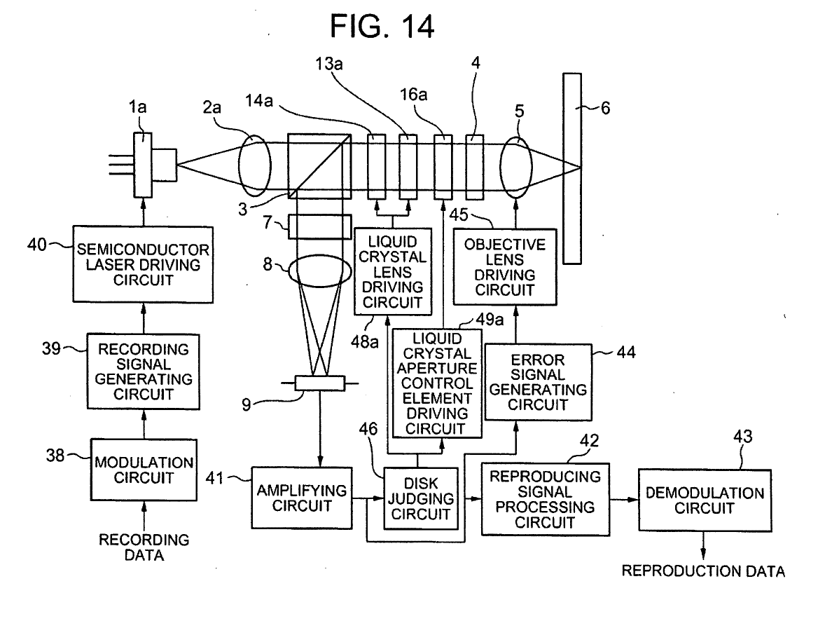

FIG. 15 is an illustration showing an optical information recording/reproducing device to which the optical head device according to the fifth exemplary embodiment of the invention is applied;

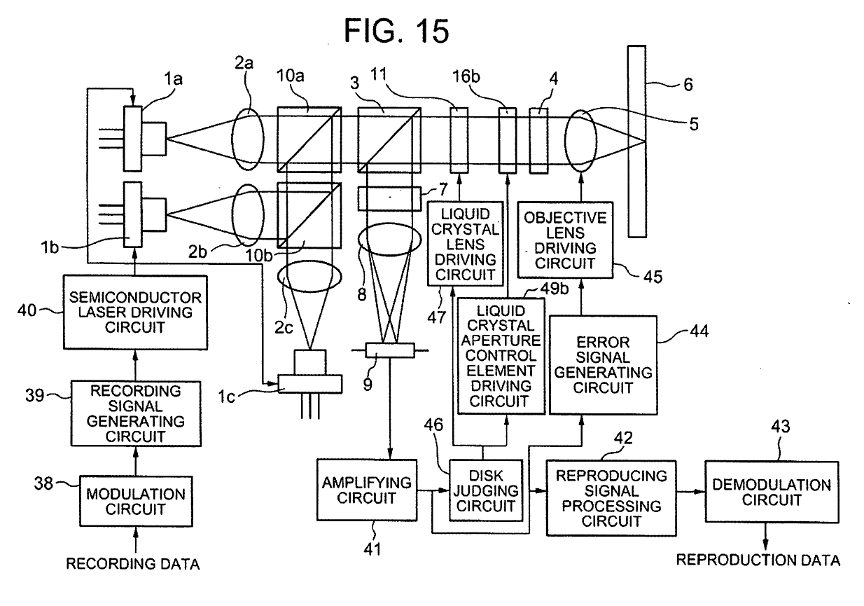

FIG. 16 is an illustration showing an optical information recording/reproducing device to which the optical head device according to the seventh exemplary embodiment of the invention is applied;

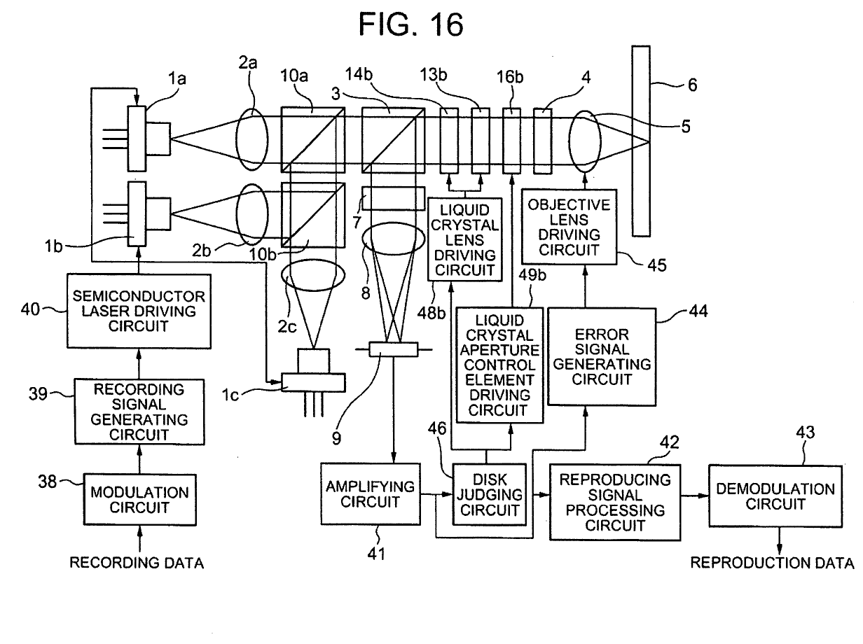

FIG. 17 is an illustration showing the structure of a related optical head device; and

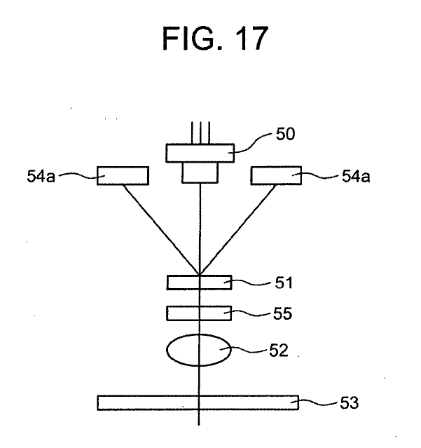

FIGS. 18A and 18B are sectional views showing a liquid crystal lens of the related optical head device.

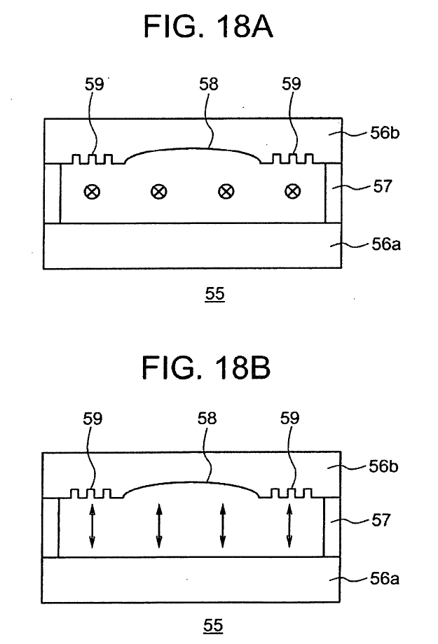

### REFERENCE NUMERALS

1a, 1b, 1c Semiconductor laser
2a, 2b, 2c Collimator lens
3 Polarizing beam splitter
5 Objective lens
6 Disk
7 Cylindrical lens
8 Convex lens
9 Photodetector
10a, 10b Interference filter
11 Liquid crystal refracting lens
12 Liquid crystal refracting lens
13a, 13b Liquid crystal diffraction lens
14a, 14b Liquid crystal refracting lens
15 Liquid lens
16a, 16b Liquid crystal aperture control element
17a Liquid crystal aperture control element
18a, 18b, 18c Substrate
19a, 19b Liquid crystal polymer
20a, 20b Filler
21a, 21b, 21c Substrate
22a, 22b Liquid crystal polymer
23a, 23b, 23c Substrate
24a, 24b Liquid crystal polymer
25a, 25b Filler
26a, 26b Substrate
27a, 27b Electrode
28 Water
29 Oil
30a, 30b, 30c Substrate
31a, 31b Liquid crystal polymer
32a, 32b Filler
33a, 33b Substrate
34 Liquid crystal polymer
35 Filler
36a, 36b, 36c, 36d Region
37a, 37b, 37c, 37d Region
38 Modulation circuit
39 Recording signal generating circuit
40 Semiconductor laser driving circuit
41 Amplifying circuit
42 Reproducing signal generating circuit
43 Demodulation circuit
44 Error signal generating circuit
45 Objective lens driving circuit
46 Disk judging circuit
47 Liquid crystal lens driving circuit
48a, 48b Liquid crystal lens driving circuit
49a, 49b Liquid crystal aperture control element driving circuit
50 Semiconductor laser
51 Beam splitter
52 Objective lens
53 Disk
54a, 54b Photodetector
55 Liquid crystal lens
56a, 56b Substrate
57 Liquid crystal polymer
58 Lens
59 Diffraction grating

1-8. (canceled)

9. An optical head device targeted to at least three kinds of optical recording media with information tracks having different optical system conditions to be used, the optical head device comprising:
an objective lens which converges emission light emitted from light sources onto the optical recording medium and forms a light focusing spot;
a photodetector which receives reflected light that is converged on the optical recording medium by the lens and reflected thereby;
a light separating device which separates the emission light and the reflected light; and
a lens system which is disposed between the light separating device and the objective lens for correcting a spherical aberration in the emission light, which changes depending on the kinds of the optical recording media, wherein
the lens system includes a diffraction-type liquid crystal lens which generates light of one of orders selected from zeroth-order diffraction light, first-order diffraction light, and second-order diffraction light depending on the kinds of the optical recording media and includes an auxiliary lens system whose focal distance can be changed continuously.

10. The optical head device as claimed in claim 9, wherein the lens system comprises an aperture control device which changes an effective numerical aperture of the objective lens depending on the kinds of the optical recording media.

11. The optical head device as claimed in claim 9, wherein the light sources are a plurality of light sources whose emission light is of different wavelength from each other.

12. An optical information recording/reproducing device which performs recording and/or reproduction of information to/from at least three kinds of optical recording media with information tracks having different optical system conditions to be used, the optical information recording/reproducing device comprising:
the optical head device of claim 9;
a first circuit system which drives the light sources of the optical head device;
a second circuit system which detects a mark/space signal formed along the information track based on an output from the photodetector of the optical head device;
a third circuit system which detects, based on the output from the photodetector, a focus error signal indicating a position shift of a light focusing spot of the optical head device with respect to the information track in an optical axis direction and a track error signal indicating a position shift within a plane that is perpendicular to the optical axis, and drives the objective lens of the optical head device based on the focus error signal and the track error signal; and
a fourth circuit system which drives the lens system of the optical head device so as to correct the spherical aberration in the emission light, which changes depending on the kinds of the optical recording media.

13. An optical head device targeted to at least three kinds of optical recording media with information tracks having different optical system conditions to be used, the optical head device comprising:
an objective lens which converges emission light emitted from light sources onto the optical recording medium and forms a light focusing spot;
photodetector means for receiving reflected light that is converged on the optical recording medium by the lens and reflected thereby;
light separating means for separating the emission light and the reflected light; and
a lens system which is disposed between the light separating means and the objective lens for correcting a spherical aberration in the emission light, which changes depending on the kinds of the optical recording media, wherein
the lens system includes a diffraction-type liquid crystal lens which generates light of one of orders selected from zeroth-order diffraction light, first-order diffraction light, and second-order diffraction light depending on the kinds of the optical recording media and includes an auxiliary lens system whose focal distance can be changed continuously.
